(19) United States
(12) Patent Application Publication
(10) Pub. No.: US 2019/0240831 A1
(43) Pub. Date: Aug. 8, 2019

(54) Robot Having Vertically Oriented Articulated Arm Motion

(71) Applicant: Kimball Electronics Indiana, Inc., Jasper, IN (US)

(72) Inventor: Anthony C. Bonora, Portola Valley, CA (US)

(21) Appl. No.: 15/888,885

(22) Filed: Feb. 5, 2018

(51) Int. Cl. B25J 9/10; B25J 15/00; B25J 9/06

(52) U.S. Cl. CPC B25J 9/106; B25J 9/06; B25J 15/0014

(57) ABSTRACT

A robotic structure providing theta-motion, R-motion and Z-motion and includes a platform. A rotatable base is mounted to the platform and is adapted to rotate in theta about the platform. A Z-tower is attached to the rotatable base, wherein the Z-tower rotates with the rotatable base. A vertical drive is configured within the Z-tower. A drive mechanism adapted to integrate with the vertical drive for linear movement along the Z-tower along a Z-axis. An arm comprising at least two linkages is rotatably attached to the drive mechanism and is further adapted for z-articulation in a corresponding vertical plane along an R-axis and the Z-axis. A gripper is adapted to attach to a pivot located at the distal end of the arm and pivotably mounted for rotation relative to the distal end, the gripper adapted to interface with a corresponding object.

### TECHNICAL FIELD

The present embodiments relate to robots, and more particularly to robots employed in automated Test and Assembly systems.

### BACKGROUND

In automated Test and Assembly systems, robots are employed to move devices or modules (Device Under Test; DUT) from one location to another. For example, one or more robots may be employed to pick up a DUT from a DUT carrier in a loading port or conveyor, move the DUT to a test position, move the DUT to one or more intermediate locations (e.g., sequential testing), and move the DUT to one or more test exit locations, depending on the test results.

Typical robots employed in test and assembly systems can be of the type commonly referred to as SCARA (selective compliance assembly robot arm) robots. These SCARA robots include jointed arms that are movable in an x-y plane but not individually movable in the z-direction. That is, the arms may be bi-fold arms movable in the horizontal plane. For example, in an arm with two links, the arm is able to extend out into a space and fold back or retract upon itself within the horizontal plane. This movement is beneficial for transferring objects from one cell to another, such as transporting DUT's to and from test positions.

However, in order to extend out further within a transport area, the footprint of the robot must increase. Because movement of the arm is performed in a horizontal plane, as the links of the arm become longer to enable greater extension, the total swing area to allow motion of the joints and links of the arm becomes larger. As such, each increase in the extension of the arm comes with an increase in the footprint of the swing area and robot.

In addition, these SCARA robots may have limited load bearing capabilities in the z-direction (e.g., the direction of gravity). Because of the motion in the horizontal plane, the links of the arm are designed to be stouter in the y-direction to handle the repeated horizontal motions. Further, with the emphasis on handling the horizontal motion, the links in the arms are less stout in the z-direction (e.g., the direction of the force on the load due to gravity). As such, unless the robot is built with large arms and a corresponding robot to handle those arms, for a given footprint typical within a Test and Assembly system the SCARA robots are limited to handling light objects.

It would be beneficial to design a robot capable of handling greater load bearing forces in the z-direction for a given robot footprint to handle a number of DUT's having varying weights.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is in this context that disclosures arise.

### SUMMARY

The present embodiments relate to solving one or more problems found in the related art, and more specifically include robots configured for vertically oriented articulated arm motions.

Embodiments of the present disclosure include a robotic structure providing theta-motion, R-motion and Z-motion. The robotic structure includes a platform and a rotatable base that is mounted to the platform, wherein the rotatable base is adapted to rotate in theta about the platform. The robotic structure includes a Z-tower that is attached to the rotatable base, wherein the Z-tower is adapted to rotate with the rotatable base. The robotic structure includes a vertical drive configured within the Z-tower. The robotic structure further includes a drive mechanism integrated with the vertical drive and adapted to linearly move along the Z-tower along a Z-axis. The robotic structure includes an arm including at least two linkages. The arm is rotatably attached to the drive mechanism and is further adapted for z-articulation in a corresponding vertical plane along an R-axis and the Z-axis. The robotic structure includes a gripper adapted to attach to a pivot located at the distal end of the arm. The gripper is pivotably mounted for rotation relative to the distal end, and is adapted to interface with a corresponding object.

Still other embodiments disclose a robotic structure providing theta-motion, R-motion and Z-motion. The robotic structure includes a platform, and a rotatable base mounted to the platform, wherein the rotatable base is adapted to rotate in theta about the platform. The robotic structure includes a Z-tower attached to the rotatable base, wherein the Z-tower rotates with the rotatable base. The robotic structure includes a vertical drive configured within the Z-tower. A drive mechanism is integrate with the vertical drive and is adapted to linearly move along the Z-tower along a Z-axis. The robotic structure includes a dual arm structure coupled to the drive mechanism. The dual arm structure includes a first arm and a second arm, wherein each arm includes at least two linkages, wherein each arm is rotatably attached to the drive mechanism and is further adapted for z-articulation in a corresponding vertical plane along an R-axis and the Z-axis. The robotic structure includes a first gripper adapted to attach to a first pivot of the first arm, wherein the first pivot is located at a distal end of the first arm. The first gripper is pivotably mounted for rotation relative to the distal end of the first arm, and wherein the first gripper is adapted to interface with a first corresponding object. The robotic structure includes a second gripper adapted to attach to a second pivot of the second arm, wherein the second pivot is located at a distal end of the second arm. The second gripper is pivotably mounted for rotation relative to the distal end of the second arm, and wherein the second gripper is adapted to interface with a second corresponding object.

Other embodiments disclose a robotic structure providing theta-motion, R-motion and Z-motion. The robotic structure includes a platform, and a rotatable base mounted to the platform and adapted to rotate in theta about the platform. The robotic structure includes a Z-tower attached to the rotatable base, wherein the Z-tower rotates with the rotatable base. The robotic structure includes a vertical drive configured within the Z-tower. A drive mechanism is adapted to integrate with the vertical drive for linear movement along the Z-tower along a Z-axis. The robotic structure includes an arm including a first linkage and a second linkage. The arm is rotatably attached to the drive mechanism and is further adapted for z-articulation in a corresponding vertical plane along an R-axis and the Z-axis. The robotic structure includes a universal interface adapted at a first end to connect to the pivot located at the distal end of the arm, and a second end of the universal interface is adapted to releasably attach to one or more grippers. Each gripper is uniquely adapted to interface with a corresponding object, wherein each gripper is pivotably mounted for rotation relative to the distal end, and wherein each gripper is adapted to interface with a corresponding object. The first linkage is attached to the drive mechanism at a rotatable shoulder joint configured for relative movement of the first linkage with respect to the drive mechanism in the corresponding vertical plane. A rotatable arm joint is adapted to connect the first linkage and the second linkage, wherein the rotatable arm joint allows for relative vertical movement between the first and second linkages in the corresponding vertical plane.

These and other advantages will be appreciated by those skilled in the art upon reading the entire specification and the claims.

### BRIEF DESCRIPTION OF THE DRAWINGS

The embodiments may best be understood by reference to the following description taken in conjunction with the accompanying drawings. The drawings are not drawn to scale.

FIG. 1 illustrates a testing system configured for testing a device (e.g., substrate, DUT, etc.), in accordance with one embodiment of the present disclosure.

FIG. 2A illustrates a perspective view of a robotic structure that is configured for vertically oriented arm motions, wherein the robotic structure includes arms rotatably attached to a gear box or other drive mechanism mounted to a back side of the robotic structure, wherein the arms extend outwards away from a front side, and wherein the robotic structure is mounted to a track system, in accordance with one embodiment of the present disclosure.

FIG. 2B illustrates a different perspective view of the robotic structure of FIG. 2A that is configured for vertically oriented arm motions, wherein the robotic structure is mounted to a track system, in accordance with one embodiment of the present disclosure.

FIG. 2C illustrates a perspective view of a robotic structure that is configured for vertically oriented arm motions, wherein the robotic structure is identical to that of FIG. 2A, wherein the robotic structure includes arms rotatably attached to a gear box or other drive mechanism mounted to a back side of the robotic structure, and wherein the arms are articulated below the gear box when extending outwards away from a front side, in accordance with one embodiment of the present disclosure.

FIG. 2D illustrates a perspective view of a robotic structure that is configured for vertically oriented arm motions, wherein the robotic structure is mounted to a fixed platform, in accordance with one embodiment of the present disclosure.

FIG. 2E illustrates a perspective view of a robotic structure that is configured for vertically oriented arm motions, and further illustrates a gripper of a transfer robot that is configured to interface with a carrier mechanism for holding a device or module (e.g., DUT), in accordance with one embodiment of the present disclosure.

FIG. 2F illustrates a perspective view of a robotic structure that is configured for vertically oriented arm motions, and further illustrates a gripper of a transfer robot that is configured to attach to a carrier (e.g., tray) for holding and interfacing with a device (e.g., mobile phone), in accordance with one embodiment of the present disclosure.

FIG. 2G illustrates a perspective view of a robotic structure that is configured for vertically oriented arm motions, and further illustrates a gripper of a transfer robot that is configured to attach directly to a substrate (e.g., mobile phone form factor) for purposes of transfer, in accordance with one embodiment of the present disclosure.

FIG. 3A is a top-view of a robotic structure that is configured for vertically oriented arm motions, wherein grippers of the robotic structure are configured for wafer handling, in accordance with one embodiment of the present disclosure.

FIG. 3B is a top-view of a robotic structure that is configured for vertically oriented arm motions, wherein grippers of the robotic structure are configured for carrying devices, such as a device under test, in accordance with one embodiment of the present disclosure.

FIGS. 4A-4I are illustrations of perspective views of a robotic structure that is configured for vertically oriented arm motions, wherein the perspective views are taken from a first vantage point having an unobstructed view of the front side of the robotic structure, wherein the perspective views show varying positions of the arms of the robotic structure including full extension, half extension, and full retraction, in accordance with embodiments of the present disclosure.

FIGS. 5A-5I are illustrations of perspective views of a robotic structure that is configured for vertically oriented arm motions, wherein the perspective views are taken from a second vantage point having an unobstructed view of the back side of the robotic structure, wherein the perspective views show varying positions of the arms of the robotic structure including full extension, half extension, and full retraction, in accordance with embodiments of the present disclosure.

FIGS. 6A-6H illustrate the use of a robotic structure within a loader of a testing system, wherein the robotic structure is configured for transporting DUTs from a multi-device carrier to one or more testing stations, in accordance with embodiments of the present disclosure.

FIG. 7 shows a control module for controlling the systems described above.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure described below are set forth without any loss of generality to, and without imposing limitations upon, the claims that follow this description.

Generally speaking, the various embodiments of the present disclosure describe robotic systems having vertically oriented articulated arm motions. In that manner, the robotic systems exhibit compact motion drives even as their extensions become larger. In particular, the robotic systems have articulated arms that are vertically oriented to enable the small footprint. Even with the small footprint, the robotic systems can be configured for highly extendible positioning of the arms for object (e.g., DUT) placement or retrieval. In addition, the vertical orientation of the arms provide for increased stiffness in the load bearing direction, as opposed to conventional robotic arms. This improved stiffness enables faster motions, less vibration, and a higher degree of placement position accuracy at drop-off/pick-up locations. Embodiments of the present disclosure are beneficial for use in a variety of applications as they provide flexible object (e.g., substrate) motion capabilities while minimizing the envelope required for the associated mechanistic support and motion guidance componentry. For example, applications benefiting from the use of robotic systems having vertically oriented articulated arm motions include substrate handling applications (e.g., DUT handling), panel display manufacturing that require multiple levels of assembly and testing for substrates, modules, manufacturing of medical appliances and/or devices (e.g., stents, microbiological devices for pharmaceutical uses, etc.). In addition, flexibility for varying motion capabilities enables optimum cost control when considering specific applications.

With the above general understanding of the various embodiments, example details of the embodiments will now be described with reference to the various drawings. Similarly numbered elements and/or components in one or more figures are intended to generally have the same configuration and/or functionality. Further, figures may not be drawn to scale but are intended to illustrate and emphasize novel concepts. It will be apparent, that the present embodiments may be practiced without some or all of these specific details. In other instances, well-known process operations have not been described in detail in order not to unnecessarily obscure the present embodiments.

Embodiments of the present disclosure relate to methods and apparatuses for performing the handling and transport of objects, including robots and/or tool systems coupled to DUT testing modules. Other embodiments are configured for handling and transport of objects using robots and/or tool systems coupled to semiconductor process modules. Various embodiments of the present disclosure may be implemented in various testing and/or process module configurations and/or systems. Further, embodiments of the present disclosure are not limited to the examples provided herein, and may be practiced in different testing and/or processing systems employing different configurations, geometries, and plasma-generating technologies, and may be practiced in different systems and/or applications requiring transport of objects, such as a testing facility transporting test objects between tool systems; fulfillment centers providing supply chain management and order processing that handle small, medium and large objects; manufacturing centers (e.g., manufacturing panel displays, smartphones, etc.); and others.

Although embodiments of the present disclosure are described herein in relation to systems for processing wafers, it is understood that the robotic systems of embodiments of the disclosure are not limited to handling wafers and are suitable for handling a variety of objects, such as when handling DUTs for testing processes.

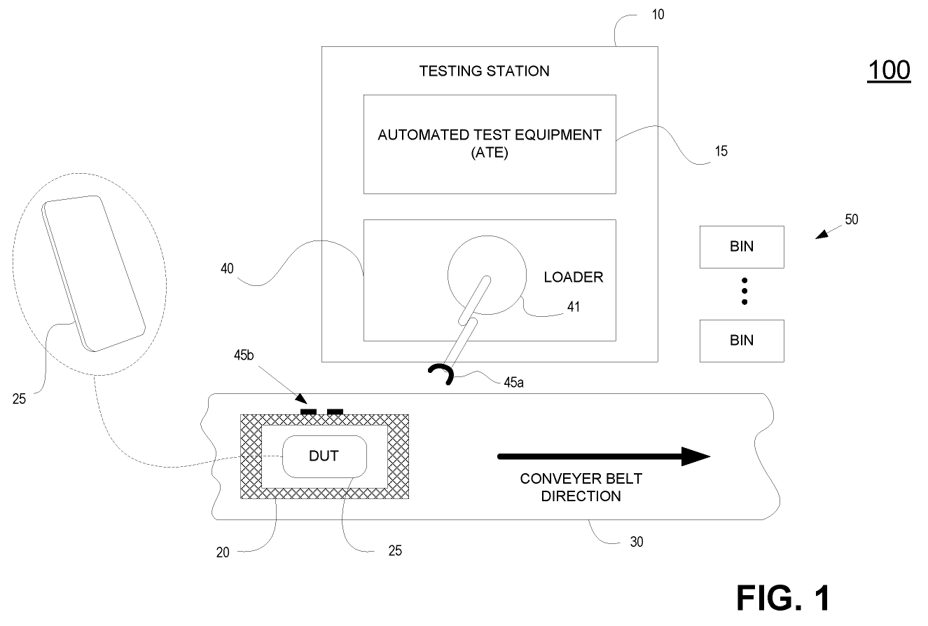

FIG. 1A illustrates a testing system 100A configured for testing a device, such as a DUT 25, in accordance with one embodiment of the present disclosure. Testing system 100A may be employed during manufacturing operations at various stages. For example, the DUT 25 may be a substrate undergoing fabrication of a plurality of devices, wherein the substrate is tested to determine whether formed devices are operating properly, and to make a decision on whether to continue manufacturing devices on that substrate based on test results. In another example, DUT 25 may be a fully manufactured device, such as a mobile phone, and a final test is performed to determine whether the device satisfies operational requirements before it can be released for sale. FIG. 1A shows an example of a DUT 25 that is a mobile phone being held by and interfacing with carrier 20.

Testing system 100A may include one or more testing stations 10, each of which is configured for performing a particular test. The testing station 10 typically includes an automated test equipment (ATE) 15 that is configured for performing one or more testing operations on the DUTs 25. In addition, testing station 10 may include a loader 40 that is configured for loading and unloading DUTs 25 into the testing environment of the ATE 15. For example, loader 40 may include robotic system 41 having vertically oriented arm motions thereby enabling exhibiting compact motion drives (e.g., minimizing the envelope required for associated mechanistic support and motion guidance componentry) independent of arm extension. The robotic system 41 may be configured for loading and unloading the DUTs. For example, robotic system 41 may be configured to interface with carriers and/or trays that hold one or more DUTs. Further, the carriers and/or trays may be configured for transporting DUTs for entry into and exit from the testing system 100A, as well as transporting DUTs within an overall system (e g, manufacturing system) to various tool systems.

Further, once a DUT 25 has been tested, the robotic system 41 may deliver the DUT 25 to a particular bin in the plurality of bins 50. For example, in the case of a fully manufactured device (e.g., mobile phone), if the test results are positive, the DUT 25 is placed into a bin holding DUTs that have passed testing by the robotic system 41. On the other hand, if the DUT 25 failed a test, the robotic system may place the DUT 25 into another bin holding DUTs that are to be repaired and retested. Test results may further be stored in a data store (not shown) of the testing system 100A.

As shown, the testing system 100A may move DUTs using test carriers 20. For instance, DUTs 25 may be moved between one or more test stations 10 using a conveyor belt 30, or any other means for transporting the DUTs via test carriers 20. For example, test carriers 20 may be transferred from one robotic system 41 to another robotic system 41 along a series of tracks, load ports, transfer modules, etc. In FIG. 1A, testing station 10 is configured with a loading mechanism, such as loader 40 including a robotic system 41, wherein the loading mechanism picks up the test carrier from the conveyer belt, and transports the test carrier 20 to the ATE 15 for testing. After testing, the robotic system 41 may transport the test carrier 20 back to the conveyer belt 30, so that the test carrier 20 may be delivered to another location, such as another testing station, repair station, exit station, packing station, etc. Robotic system 41 may also transport the test carrier 20 directly to another test station 10. Further, robotic system 41 may deliver the test carrier 20 to a bin depending on testing results, as previously described.

The test carrier 20 includes a receiver 45b that is configured to mate with an interface 45a of the gripper (e.g., gripper 240A) of robotic system 41. In that manner, the robotic system 41 is able to pick up the test carrier 20 for transporting purposes. In addition, the test carrier 20 may serve as an interface between the DUT 25 and the ATE 15 to the testing station 10. That is, the test carrier 20 may be configured to mate with the testing station 10 directly, instead of the DUT 25. For example, the test carrier 20 may be more sturdy and better equipped to handle the interface with the testing station 10, when compared to the DUT 25.

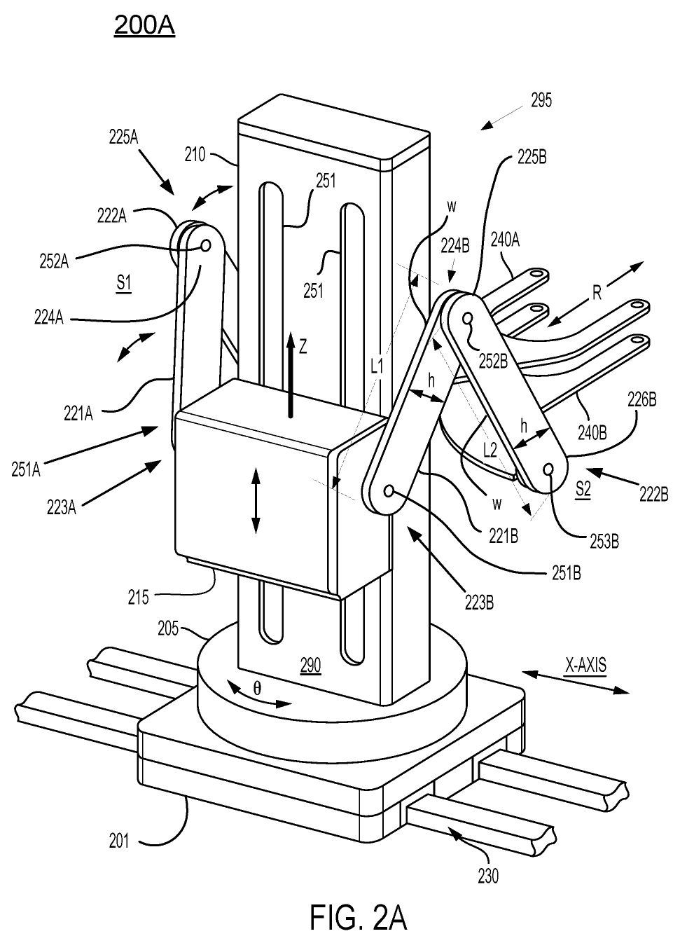

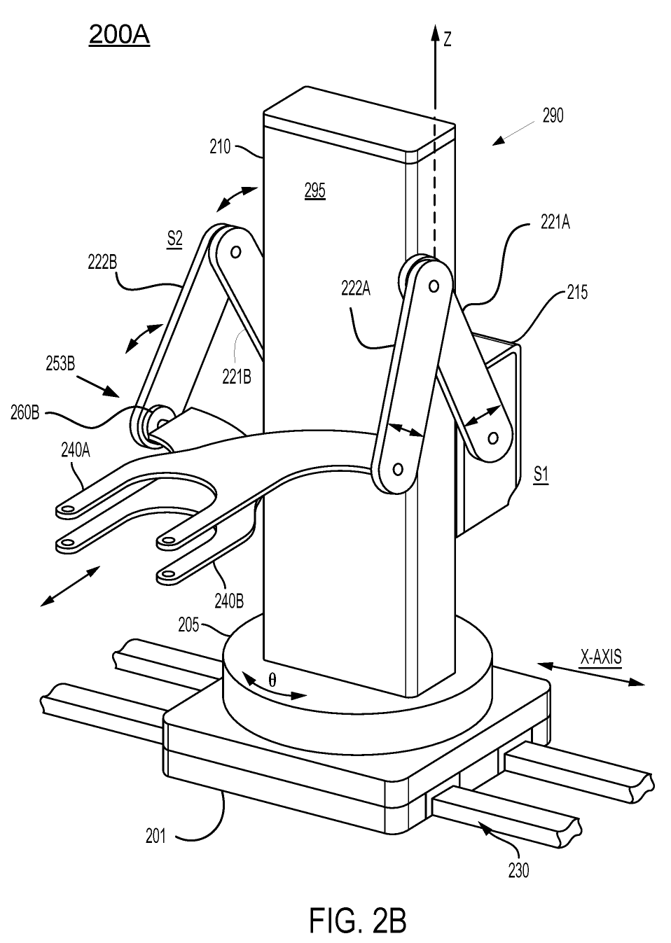

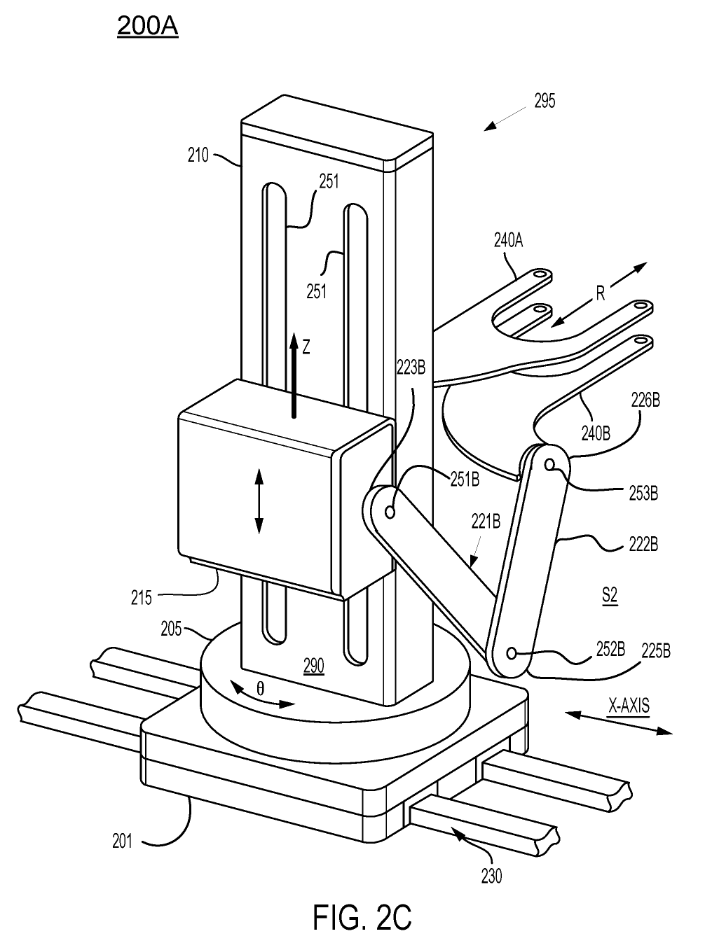

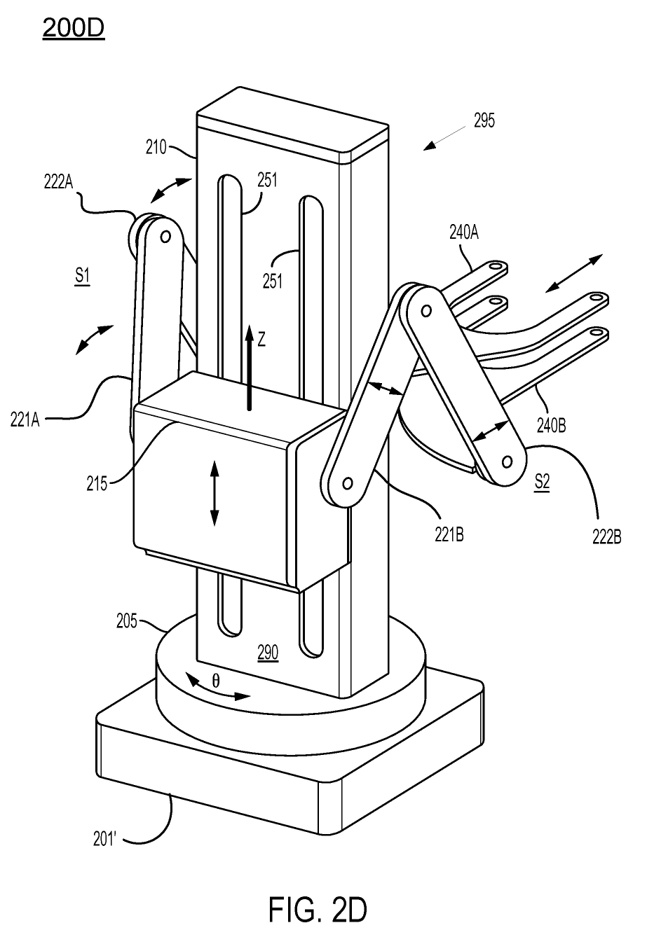

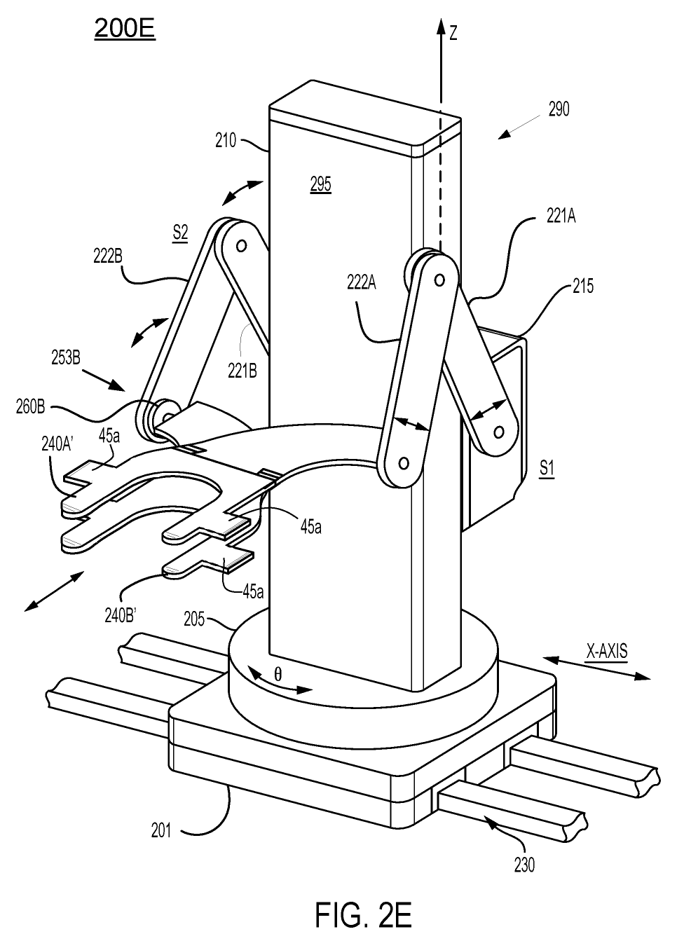

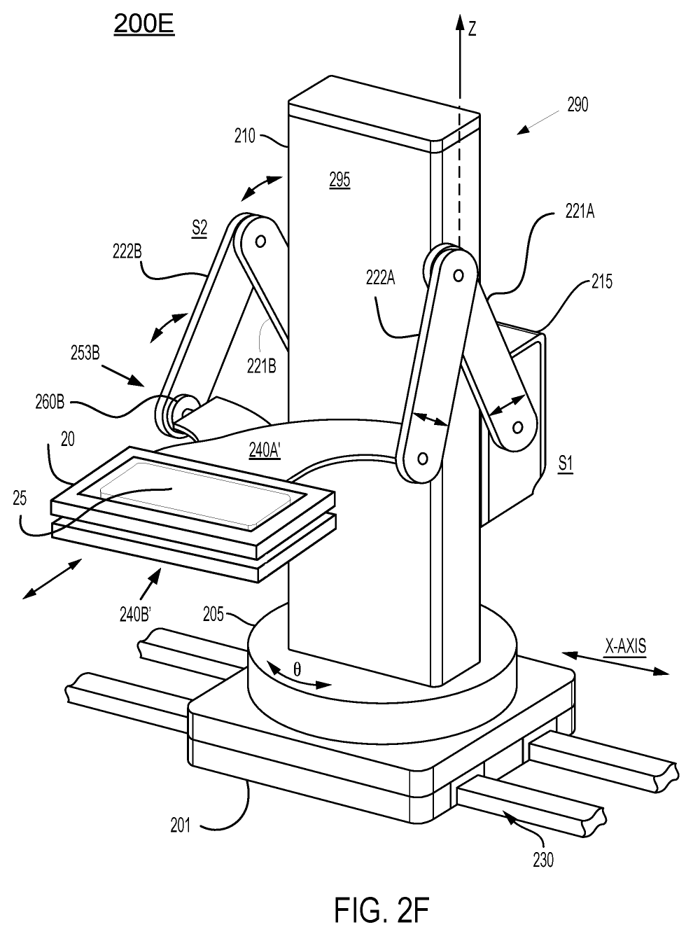

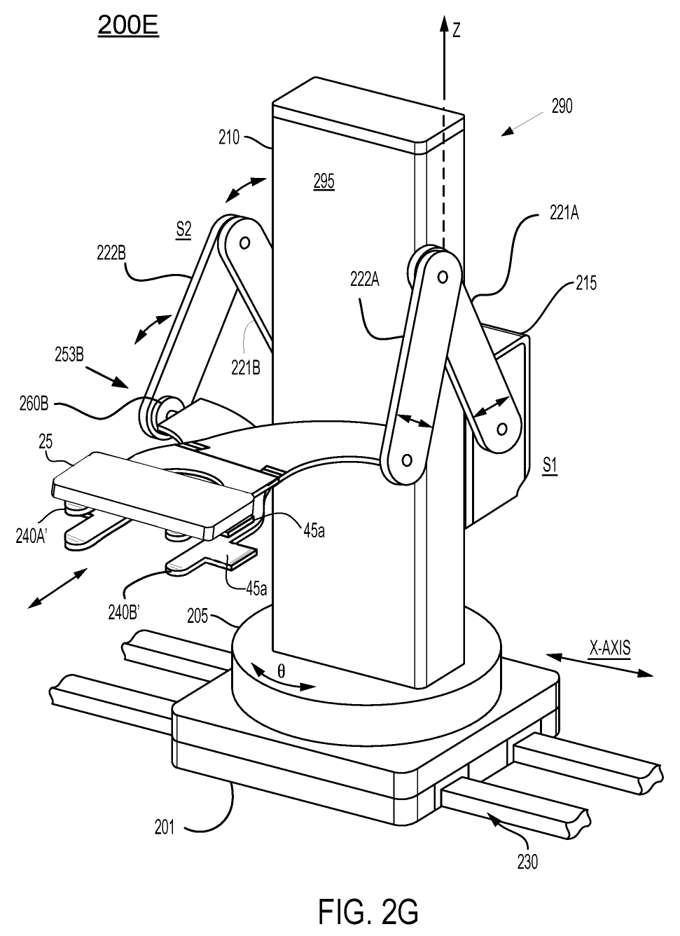

FIGS. 2A-2E illustrate various embodiments of robotic structures, each of which are configured for vertically oriented arm motions. The robotic structures are similarly configured in FIGS. 2A-2E and where applicable include similarly numbered elements that may also be used throughout the specification. The robotic structures of FIGS. 2A-2E and throughout this specification are configured for handling various objects and/or devices, in accordance with embodiments of the present disclosure. For instance, in some embodiments, robotic structures (e.g., 200A) are configured for handling wafers and/or substrates, wherein the robotic structure includes grippers configured with and/or interfacing with end effectors. Other embodiments disclose robotic structures (e.g., 200E) that are configured for handling DUTs, wherein the robotic structure includes gripers configured with and/or interfacing with carriers and/or trays. As previously described, other embodiments disclose the use of other types of grippers configured for handling any of a variety of objects, carriers, trays, DUTs, etc.

FIG. 2A illustrates a perspective view of a robotic structure 200A that is configured for vertically oriented arm motions, in accordance with one embodiment of the present disclosure. In particular, the robotic structure 200A includes arms S1 and S2 extending out from a back side 290. Further, the robotic structure 200A is shown with a track system 230 thereby enabling movement of the robotic structure 200A, in part, along the X-axis. It is important to note that in other embodiments, the robotic structure 200A is not coupled to a track system, as will be further described in relation to FIG. 2D. Additional description of the robotic structure 200A follows.

The robotic structure 200A provide theta (θ) motion along a θ-axis, R-motion along a radial axis (R-axis), and Z-motion along a Z-axis. Though not shown in detail, the θ-axis, R-axis, Z-axis, and X-axis are known in the art and do not require further disclosure. For instance, the θ-axis may have a particular orientation in space enabling positioning of the robotic structure 200A at a particular theta angle. In addition, the R-axis may define a R-distance for any particular theta angle. Further, the Z-axis defines motion of the robotic arms S1 and S2 in the Z-direction. Also, the X-axis may define a direction of a section of a track, wherein the X-axis may define motion of the robotic system in the X-direction within a horizontal plane.

The robotic structure 200A includes a platform 201 upon which additional components are added. Platform 201 provides a rigid structure such that the various motions of the robotic structure 200A can be repeated with accuracy. As shown, platform 201 is adapted to moveably interface with track system 230, such that the platform 201 is movable in the X-direction along the X-axis, at least for a section of the track system 230. For example, a linear drive is included in robotic structure 200A (e.g., within platform 201) to enable movement of the platform along the X-axis. As such, robotic structure 200A is also movable in the X-direction through the movement of platform 201.

In addition, a rotatable base 205 is rotatably mounted to the platform 201. That is, rotatable base 205 is adapted to rotate in theta about the platform 201. A rotational drive (not shown) may be included in the robotic structure 200A to enable theta movement. The robotic structure 200A also includes a vertically oriented Z-tower 210 (also referred to as a Z-mast) that is fixedly attached to the rotatable base 205. As such, the Z-tower 210 rotates with the rotatable base 205. In that manner, the robotic structure 200A can be oriented in any theta-direction for purposes of retracting and extending out the arms S1 and S2, such as to pick-up and/or drop-off objects, or for positioning when moving the robotic structure 200A along track system 230.

A vertical drive (not shown) is configured within the Z-tower 210. Gear box 215 or other drive mechanism is adapted to integrate with the vertical drive for linear movement of the gear box 215 along the Z-tower in the Z-direction, or along the Z-axis. As shown, slots 251 located on the back side 290 of the Z-tower allow for the gear box 215 to integrate with the vertical drive within the Z-tower 210. The vertical drive may include a ball slide assembly, wherein the gear box 215 is adapted to attach to the ball slide assembly for movement along the Z-axis. In one embodiment, the gear box 215 includes control and motor drive components to facilitate movement of the gear box.

Throughout the specification, the motion drives for the articulated vertically oriented arms (e.g., S1 and/or S2) can utilize a variety of solutions. For example, harmonic or planetary drives with either integrated motors or timing belt driven motors may be incorporated, in one embodiment. Alternately, direct-drive motors may be utilized to provide angular motion, in another embodiment. High resolution encoders can be employed with either drive solution in embodiments. For example, control of the linkages 221A and 22A is shown being provided by gear box 215, however, any mechanism or means may be used for controlling the one or more linkages of a corresponding arm. For example, other control mechanism may include the previously described drives, a direct drive, chain drive, a radial drive, etc. further, gear box 215 may be configured with one or more of these drives for controlling the vertically oriented arms of the robotic system.

Means for preventing contamination of the enclosed system within which the robotic structure 200A resides is provided in embodiments of the present disclosure. The contamination may originate through moving parts of the robotic structure 200A. For example, covers may be provided over slots 251. In addition, protective covers may be provided over joints or pivot points allowing for movement of the arms S1 and S2, or other components.

In addition, the robotic structure 200A includes arms S1 and S2 rotatably attached to a gear box 215 mounted to a back side 290 of the robotic structure 200A, wherein each of the arms S1 and S2 extend outwards away from a front side 295.

Although FIG. 2A shows that the robotic structure 200A includes two arms, embodiments of the present invention can support a robotic structure having one or more arms. That is, the robotic structure 200A may be configured as a single arm structure, or as a dual arm structure (as is shown in FIG. 2A). More particularly, in either configuration, each of the arms (e.g., S1 and S2) include at least two linkages. Further, each arm (e.g., S1 and S2) is rotatably attached to the gear box 215, and is further adapted for z-articulation in a corresponding vertical plane along the R-axis and Z-axis.

For purposes of brevity and clarity, a full discussion of arm S1 follows, and is intended to be representative of any arm included within a robotic structure, such as arm S2.

For example, arm S1 includes linkage 221A and linkage 222A. Arm S1 is rotatably attached to the gear box 215, and more specifically, linkage 221A is attached to the gear box 215 at a rotatable shoulder joint 251A (hidden) that is configured to allow relative movement of the linkage 221A with respect to the gear box (or other drive mechanism) in a corresponding vertical plane (e.g., defined by a theta angle orientation of the robotic structure 200A). That is, the linkage 221A includes a proximal end 223A and a distal end 224A, wherein the linkage 221A at the proximal end 223A is adapted to pivot about the rotatable shoulder joint 251A of the gear box 215. In addition, the linkage 222A includes a proximal end 225A and a distal end 226A (hidden).

In addition, arm S1 includes a rotatable arm joint 252A that connects linkage 221A and linkage 222A. For instance, rotatable arm joint 252A couples the distal end 224A of linkage 221A and the proximal end 225A of linkage 222A. The rotatable arm joint 252A is adapted to allow for relative movement between the linkages 221A and 222A in the corresponding vertical plane, previously described. That is, each of the linkages 221A and 222A can rotate about each other about the rotatable arm joint 252A. The rotatable shoulder joint 251A and rotatable arm joint 252A enable linkages 221A and 222A to have Z-articulation in the corresponding vertical plane along the R-axis and the Z-axis. As such, linkages 221A and 222A may be oriented to enable retraction and extension of the arm S1 along an R-axis.

Though joints are described for the rotatable shoulder joint 251A and rotatable arm joint 252A connecting linkages 221A and 222A and gear box 215 (or other drive mechanism), other mechanisms are supported that are configured for providing pivoting capabilities or rotation about a point, to include bearings, etc.

As shown, linkages 221A and 222A of arm S1 are oriented to increase the load bearing capabilities of arm S1 in the Z-direction (e.g., forces on arm S1, grippers, and held objects due to gravity), in one embodiment. For example, a cross-section of each of the linkages 221A and 222A exhibits a wider dimension in the load bearing direction. That is, the height “h” is greater than the width “w” of each linkage 221A and 222A. This provides better stiffness of the arm S1 (e.g., without horizontal bending) to handle downward forces in the Z-direction.

In addition, in another embodiment to provide additional support in the Z-direction, linkage 221A may be of lesser length than linkage 222A. That is, a first length of the linkage 221A between the rotatable shoulder joint 251A and the rotatable arm joint 252A is shorter than a second length of the linkage 222A to increase stiffness of the arm S1 in the vertical or load bearing direction.

A gripper 240A is adapted to attach to a pivot 253A (not shown) that is located at the distal end 226A of arm S1. The gripper 240A is pivotably mounted for rotation relative to the distal end 226A. In addition, the gripper 240A is adapted to interface with a corresponding object. For example, in one implementation, gripper 240A is an end-effector that is configured for handling DUTs. In another implementation, the end-effector may be configured for handling substrates, or wafer substrates. In still another implementation, gripper 240A is configured for handling carriers, wherein the carrier may be used for transporting objects. For example, a carrier may be shaped as a basket into which objects may be placed, and out of which object may be removed. Purely for illustration, the carrier may be employed in a fulfillment center, or the carrier may be employed in a manufacturing setting to move components from one location to another, such as when building panel displays. For instance, gripper 240A may be adapted to handle or connect with a container having a receptacle area for holding one or more objects.

Arm S2 is similarly configured as arm S1. Arm S2 is rotatably attached to one side of gear box 215, while arm S1 is rotatably attached to an opposing side of gear box 215, in one embodiment. In other embodiments, one or more arms may be rotatably attached to one side of gear box 215, while the opposing side may be configured to have no arms, or with one or more arms.

In summary, arm S2 includes linkage 221B and linkage 222B. Arm S2 is rotatably attached to the gear box 215, wherein linkage 221B is attached to the gear box 215 at a rotatable shoulder joint 251B that is configured to allow relative movement of the linkage 221B with respect to the gear box in a corresponding vertical plane (e.g., defined by a theta angle orientation of the robotic structure 200A). That is, the linkage 221B includes a proximal end 223B and a distal end 224B, wherein the linkage 221B at the proximal end 223B is adapted to pivot about the rotatable shoulder joint 251B of the gear box 215. In addition, the linkage 222B includes a proximal end 225B and a distal end 226B.

Further, arm S2 includes a rotatable arm joint 252B that connects linkages 221B and 222B. For instance, rotatable arm joint 252B couples the distal end 224B of linkage 221B and the proximal end 225B of linkage 222B. The rotatable arm joint 252B is adapted to allow for relative movement between the linkages in the corresponding vertical plane, previously described. That is, each of the linkages 221B and 222B can rotate about each other about the rotatable arm joint 252B. The rotatable shoulder joint 251B and rotatable arm joint 252B enable linkages 221B and 222B to have Z-articulation in the corresponding vertical plane along the R-axis and the Z-axis to enable retraction and extension of the arm S2 along an R-axis. Previously described motion drives may be used for the vertically oriented arm movement of S2.

As shown, linkages 221B and 222B of arm S2 are oriented to increase the load bearing capabilities of arm S2 in the Z-direction (e.g., forces on arm S2, grippers, and held objects due to gravity), in one embodiment. For example, a cross-section of each of the linkages 221B and 222B exhibits a wider dimension in the load bearing direction, as previously described. In addition, in another embodiment to provide additional support in the Z-direction, linkage 221B may be of lesser length than linkage 222B.

A gripper 240B is adapted to attach to a pivot 253B that is located at the distal end 226B of arm S2. The gripper 240B is pivotably mounted for rotation relative to the distal end 226B. In addition, the gripper 240B is adapted to interface with a corresponding object. For example, in one implementation, gripper 240B is an end-effector that is configured for handling DUTs, and in other implementations can be configured for handling other objects (e.g., wafers, wafer substrates, devices, objects, etc.). In another implementation, the gripper 240B is adapted to handle or connect with a container having a receptacle area suitable for holding one or more objects

FIG. 2B illustrates a different perspective view of the robotic structure 200A of FIG. 2A that is configured for vertically oriented arm motions, wherein the robotic structure is mounted to a track system, in accordance with one embodiment of the present disclosure. In particular, in FIG. 2B, the front side 295 of the Z-tower 210 is visible, wherein the front side 295 was hidden in FIG. 2A. As shown, front panel 295 is opaque in one embodiment. This may beneficial for keeping contaminants from exiting the robotic structure 200A.

In one embodiment, robotic structure 200A may optionally include a universal interface that is adapted to releasably attach to one or more types of grippers, wherein each gripper is uniquely adapted to interface with a corresponding object. For example, one gripper may be adapted to interface with an end-effector for handling wafer substrates. In another example, another gripper may be adapted to interface with a carrier for holding objects. As shown in FIG. 2B, in arm S2 the pivot 253B may interface with a universal interface 260B, wherein the universal interface 260B includes a first end that is adapted to rotatably connect to the pivot 253B. The universal interface 260B may include a second end that is adapted to releasably attach to one or more grippers. That is, universal interface 260B may be controlled to releasably attach to a selectable gripper. Though not shown, arm S1 may optionally include a universal interface 260A (hidden). One or more grippers may be arranged in a holding area, such that the universal interface 260B may attach a selected gripper from the holding area, or may detach an attached gripper from the universal interface 260B and place the detached gripper into the holding area. Sensors and ID tags may be employed for section to determine which gripper to attach to the universal interface.

FIG. 2C illustrates a perspective view of a robotic structure 200A previously introduced in FIGS. 2A-B that is configured for vertically oriented arm motions, wherein the robotic structure includes arms rotatably attached to a gear box or other drive mechanism mounted to a back side of the robotic structure, and wherein the arms are articulated below the gear box when extending outwards away from a front side, in accordance with one embodiment of the present disclosure. The robotic structure 200A shown in FIG. 2C illustrates the same perspective view as presented in FIG. 2A, except that arm S2 is oriented downwards when extending and retracting (e.g., linkages 221B and 22B are positioned downwards). That is, pivot 252B, joining linkages 221B and 222B, is below the end-effector 240B, such that movement of the linkages 221B and 22B when extending and retracting arm S2 occur below the gripper 240B (e.g., end-effector). In one implementation, robotic structure 200A of FIG. 2C is optionally mounted to a track system 230.

FIG. 2D illustrates a perspective view of a robotic structure 200D that is configured for vertically oriented arm motions, in accordance with one embodiment of the present disclosure. The robotic structure 200D is similarly configured as the robotic structure 200A of FIGS. 2A-2B, except that the robotic structure 200D is mounted to a fixed platform 201′. As such, the robotic structure 200D is fixed to a particular location within a space, and is further configured to provide theta (θ) motion along a θ-axis, R-motion along a radial axis (R-axis), and Z-motion along a Z-axis, as previously described.

FIGS. 2E-F illustrates perspective views of a robotic structure 200E that is configured for vertically oriented arm motions, and further illustrates a gripper of a transfer robot that is configured to interface with a carrier or tray portion or mechanism 20 for holding a device or module (e.g., DUT), in accordance with one embodiment of the present disclosure. In FIG. 2E, the grippers 240A′ and 240B′ are shown in isolation, whereas in FIG. 2F, the grippers 240A′ and 240B′ are shown interfacing with a carrier or tray 20.

Specifically, FIG. 2E illustrates a perspective view of a robotic structure 200E that is configured for vertically oriented arm motions, and further illustrates grippers 240A′ and 240B′ of a transfer robot that is configured as or configured to handle a carrier portion 20 for holding and/or interfacing with a substrate or module (e.g., DUT), in accordance with one embodiment of the present disclosure. As previously described, the robotic structure 200E provides theta (θ) motion along a θ-axis, R-motion along a radial axis (R-axis), and Z-motion along a Z-axis. Though not shown in detail, the θ-axis, R-axis, Z-axis, and X-axis are known in the art and do not require further disclosure.

In particular, the robotic structure 200E is similar in structure to the robotic structure 200A of FIGS. 2A-2B, except that the grippers 240A′ and 240B′ are configured to interface with carriers 20 (not shown in FIG. 2E) instead of comprising or interfacing with substrate or wafer handlers. For example, grippers 240A′ and 240B′ are configured to interface with and/or handle a carrier portion 20, wherein the carrier portion 20 is configured to interface and handle a DUT 25. In addition, the grippers 240A′ and 240B′ each may be configured to attach and detach the carrier portion 20 so that the corresponding DUT 25 may be transported to another testing location (as previously described), while still held by the carrier portion 20. For example, gripper 240A′ may include an interface 45a that is configured to mate with a receiver (not shown) located on the carrier tray.

FIG. 2F illustrates the robotic structure 200E that is interfacing with carrier portions 20, in accordance with one embodiment of the present disclosure. In particular, grippers 240A′ and 240B′ are shown interfacing with corresponding carrier portions 20. For example, gripper 240A′ is interfacing with a carrier portion 20, wherein the carrier portion 20 is handling a DUT 20. Carrier portions 20 may be configured to hold one or more DUTs, though one DUT is shown. As previously described, grippers 240A′ may be configured to attach and detach the carrier portion 20. It is understood that in embodiments grippers (e.g., gripper 240A′ and 240B′) may be configured to be smaller or larger or of similar size than the object (e.g., carrier 20) being handled. For example, different grippers may be smaller than the substrate footprint, or extend beyond the substrate footprint, or may be of similar size with the substrate footprint when supporting substrate transfers

FIG. 2G illustrates a perspective view of the robotic structure 200E that is configured for vertically oriented arm motions, and further illustrates a gripper 240A′ and 240B′ of a transfer robot that is configured to attach directly to or interface with a substrate 25 (e.g., mobile phone form factor) for purposes of transfer, in accordance with one embodiment of the present disclosure. In particular, gripper 240A′ is shown directly interfacing with substrate 25. As shown, the gripper 240A′ is configured to removably attach to substrate 25. For example, ridges or other holding means on the gripper 240A′ may be positioned to fixedly hold substrate 25 in place during transport. In addition, the ridges or other holding means are configured to release the substrate 25 upon demand (e.g., application of proper lifting force). It is understood that in embodiments grippers (e.g., gripper 240A′ and 240B′) may be configured to be smaller or larger or of similar size than the object (e.g., substrate 25) being handled. For example, different grippers may be smaller than the substrate footprint, or extend beyond the substrate footprint, or may be of similar size with the substrate footprint when supporting substrate transfers.

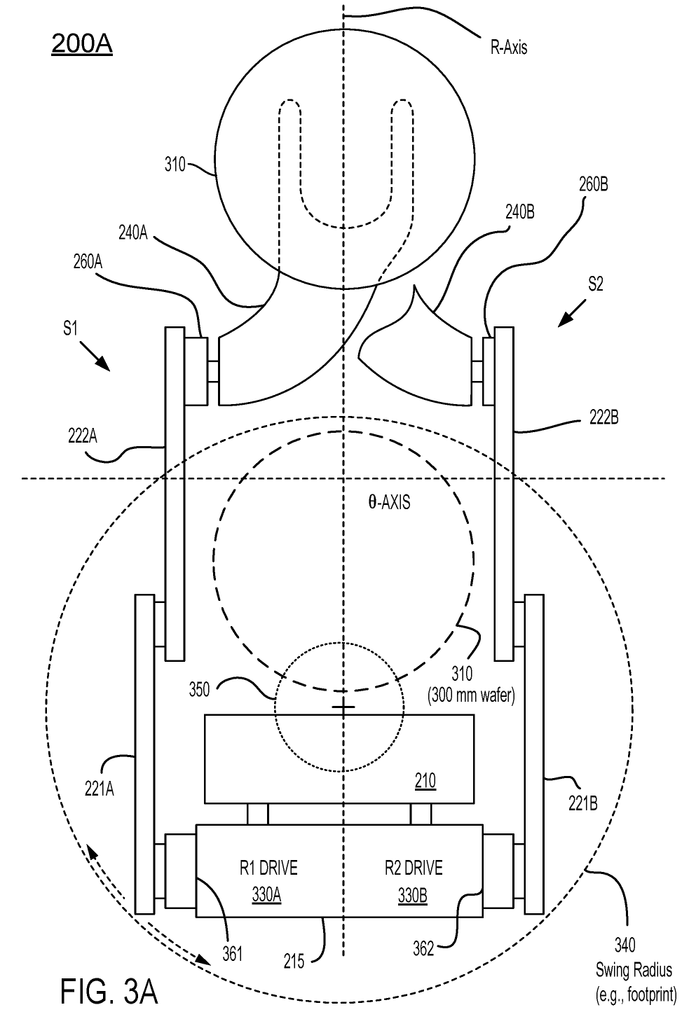

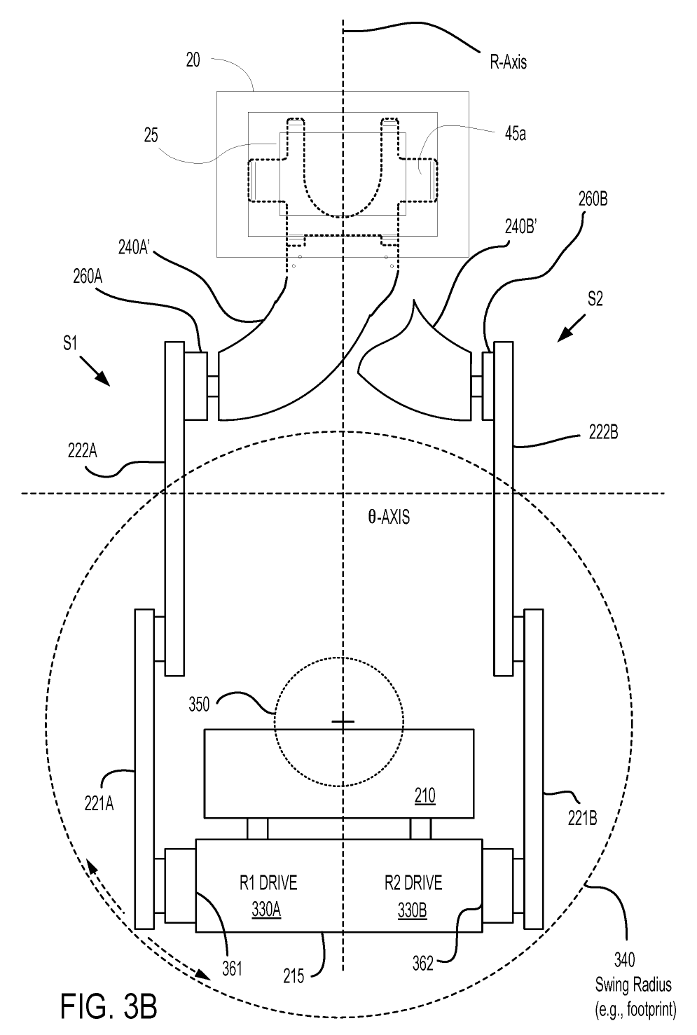

FIG. 3A is a top-view of a robotic structure 200A, previously introduced in FIGS. 2A-2B, that is configured for theta based, vertically oriented articulated arm motions, in accordance with one embodiment of the present disclosure. In particular, the vertically oriented arm motions include the extension and retraction of arms in the R-direction. As previously described, the robotic structure 200A provides theta (θ) motion about a θ-axis, R-motion along a radial axis (R-axis), and Z-motion along a Z-axis. The exemplary robotic structure 200A of FIG. 3A includes one or more grippers 240A and 240B configured for substrate or wafer handling, though robotic structures may include any type of gripper configured for handling various types of modules and/or devices.

As previously described robotic structure 200A includes a platform 201 (not shown) and a rotatable base 205 (not shown) that is rotatably mounted to the platform and adapted to rotate in theta about the platform. Theta housing 350 includes a theta motor and/or drive for rotation of the rotatable base 205 about the θ-axis.

A vertically oriented Z-tower 210 is fixedly attached to the rotatable base 205. As such, the Z-tower 210 rotates with the rotatable base 205 about the θ-axis. In that manner, the robotic structure 200A can be oriented in any theta-direction for purposes of retracting and extending out the arms S1 and S2, such as to pick-up and/or drop-off objects, or for positioning when moving the robotic structure 200A along a track system (not shown). Z-tower may be configured to include a vertical drive, Z-linear guides (e.g., ball slide assemblies), Z₁ and Z₂ motors, ball screw assemblies, and theta bearings. Gear box 215 or other drive mechanism is adapted to integrate with the vertical drive for linear movement of the gear box 215 along the Z-tower in the Z-direction, or along the Z-axis.

In addition, the robotic structure 200A includes arms S1 and S2 rotatably attached to the gear box 215, as previously described. For example, arm S1 is rotatably attached to the side 361 of gear box 215, and arm S2 is rotatably attached to the opposing side 362. In particular, arm S1 includes linkages 221A and 222A, as previously described. Gripper 240A is rotatably attached to linkage 222A. For example, gripper 240A may be an end-effector that is adapted to handle a wafer, such as the 300 mm wafer shown in FIG. 3A. An optional universal interface 260A may by adapted to rotatably attach to the linkage 222A, and be further adapted to releasably attach to gripper 240A. The motion R-1 drive 330A provides controlled motion for the articulated vertically oriented arm S1, and can utilize a variety of solutions, such as harmonic or planetary drives including integrated or timing belt driven motors, direct drive motors, chain drives, radial drives, etc.

In FIG. 3A and in other figures throughout the specification, the substrate 310 is shown having a size (e.g., diameter) that is larger than the footprint of the gripper 240A. That is, the width of the gripper 240A (e.g., dimension between the extensions of the end-effector) may be smaller than the diameter of the substrate 310. However, it is understood that the size of substrate 310 or of any other object that is being handled by gripper 240A (e.g., substrate, DUT, device, etc.) is variable. As such, the object, being handled by the corresponding gripper, may be smaller or larger than or of equal size as the corresponding gripper. That is, different grippers may be configured to be smaller or larger or of similar size than the object being handled. For example, different grippers may be smaller than the substrate footprint, or extend beyond the substrate footprint, or may be of similar size with the substrate footprint when supporting substrate transfers.

Further, arm S2 includes linkages 221B and 222B, as previously described. Gripper 240B is rotatably attached to linkage 222B. An optional universal interface 260B may by adapted to rotatably attach to the linkage 222B, and be further adapted to releasably attach to gripper 240B. The motion R-2 drive 330B provides controlled motion for the articulated vertically oriented arm S2, and can utilize a variety of solutions, such as harmonic or planetary drives including integrated or timing belt driven motors, direct drive motors, chain drives, radial drives, etc.

Line 340 defines a swing radius or footprint of the robotic structure 200A, when the arms S1 and S2 are fully retracted. In one case, the swing radius is defined to include fully retracted arms S1 and S2 while handling wafers 310, as is shown by the outline of a wafer 310. For example, the swing radius may be approximately 13 inches for a robotic structure 200A handling a 300 mm wafer.

In one embodiment, arms S1 and S2 can be offset in the Z-direction when rotatably attached to the gear box 215. That is, arm S1 may be slightly higher in Z than arm S2 when attached to the gear box 215, or vice versa. In that manner, when arms S1 and S2 are both fully extended, respective grippers 240A and 240B will not interfere with each other. At full extension, grippers 240A and 240B are positioned above and below each other without interference, such that gripper 240A may be above gripper 240B in the Z-direction, or vice versa.

FIG. 3B is a top-view of a robotic structure 200E, as introduced in FIGS. 2E-2F, that is configured for vertically oriented arm motions, wherein grippers 240A′ and 240B′ of the robotic structure 200 are configured for interfacing with carrier portions 20 that are each configured for handling substrates, modules, such as a DUT, in accordance with one embodiment of the present disclosure. As previously described, robotic structure 200E is similarly configured as the robotic structure 200A of FIGS. 2A-2B, except that the grippers 240A′ and 240B′ are configured as DUT handlers instead of wafer handlers. As shown, gripper 240A′ includes an interface 45a that is configured to mate with a receiver (not shown) located on the carrier portion 20. For example, carrier portions 20 are configured to interface with and handle (e.g., support) a DUT 25, such as a mobile phone. In addition, the grippers 240A′ and 240B′ each may be configured to attach and detach the carrier portion 20 so that the corresponding DUT may be transported to another testing location (as previously described), while still held by the test carrier 20.

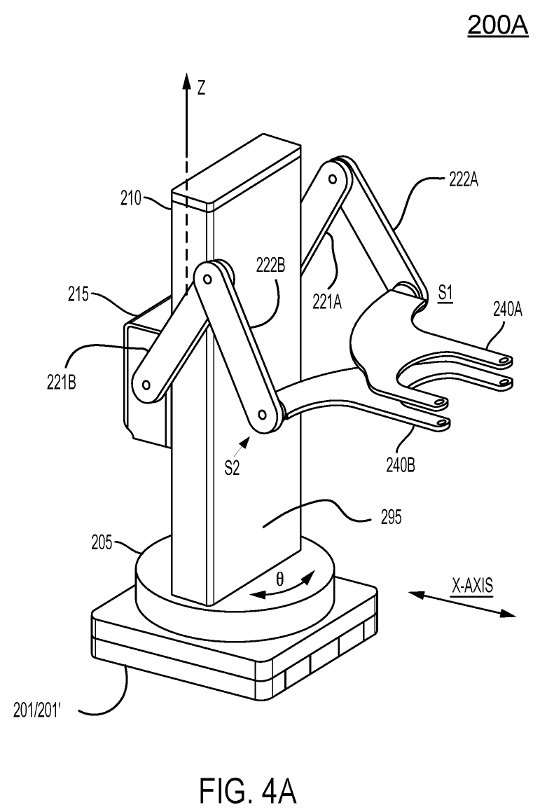

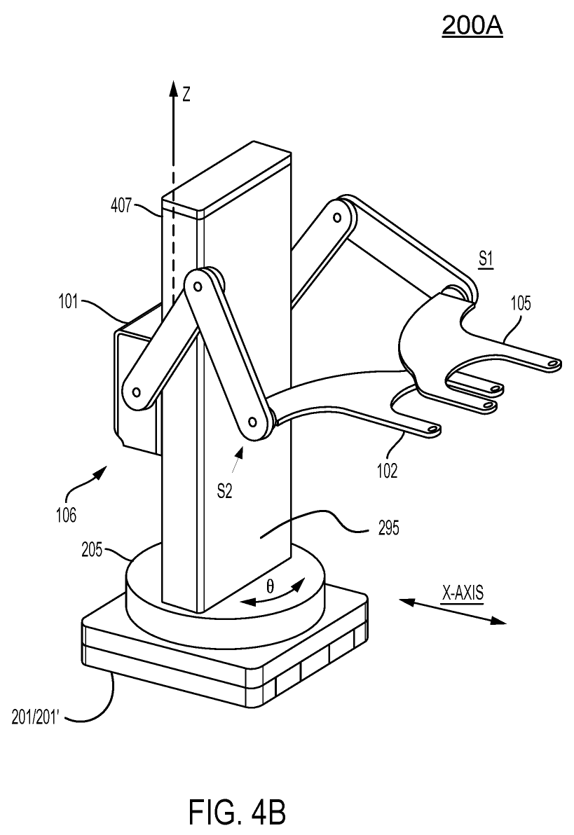

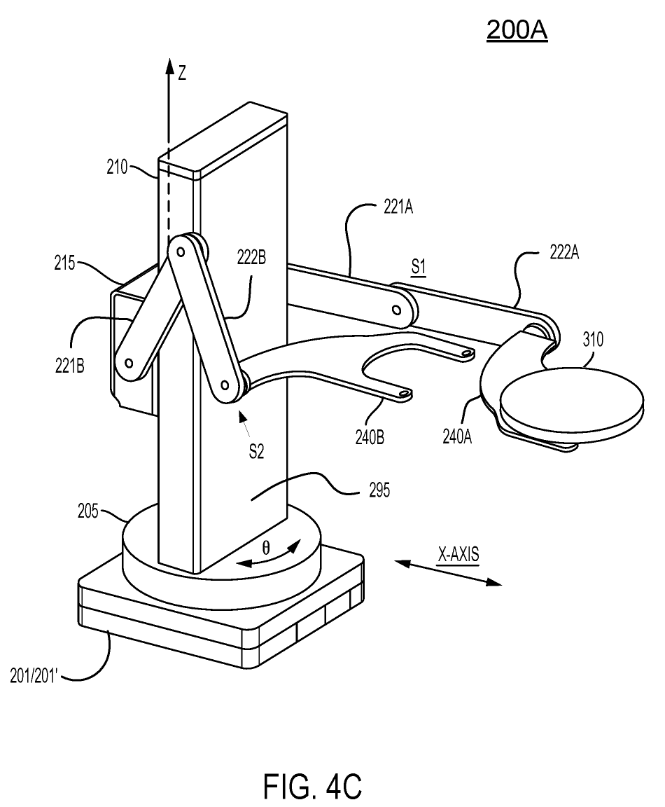

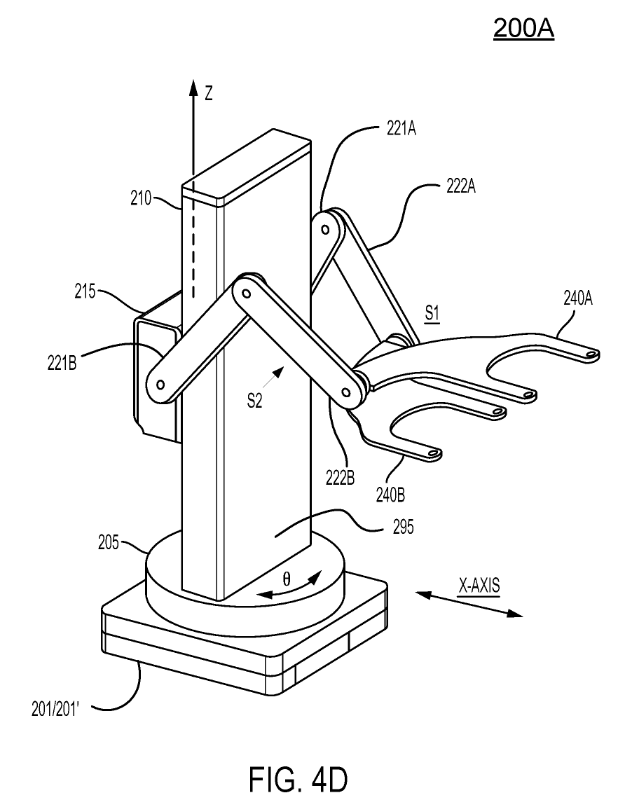

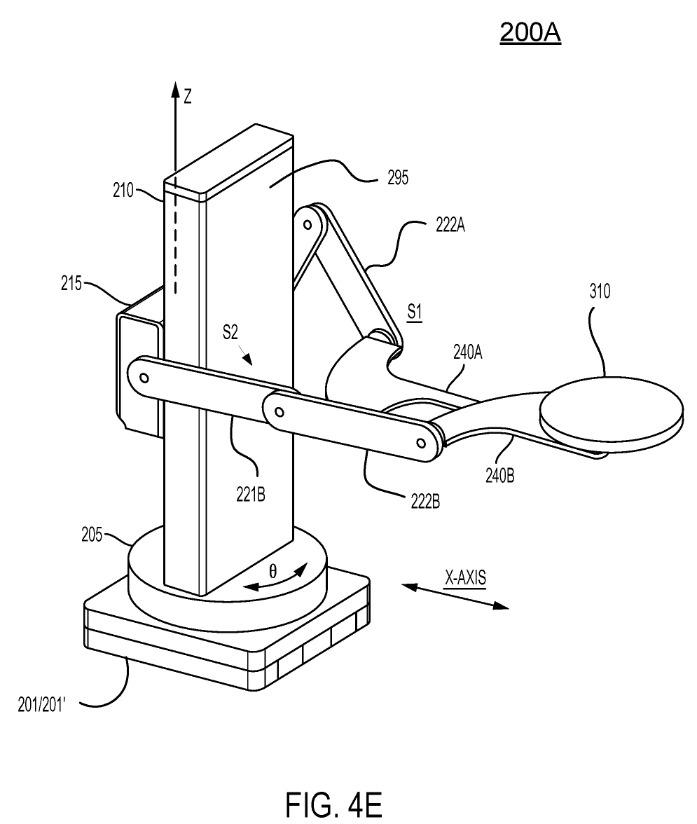

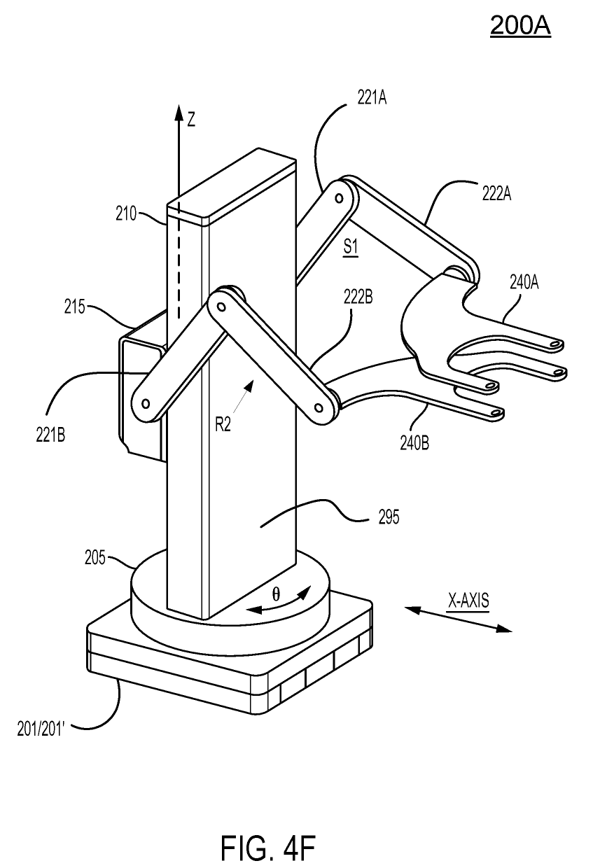

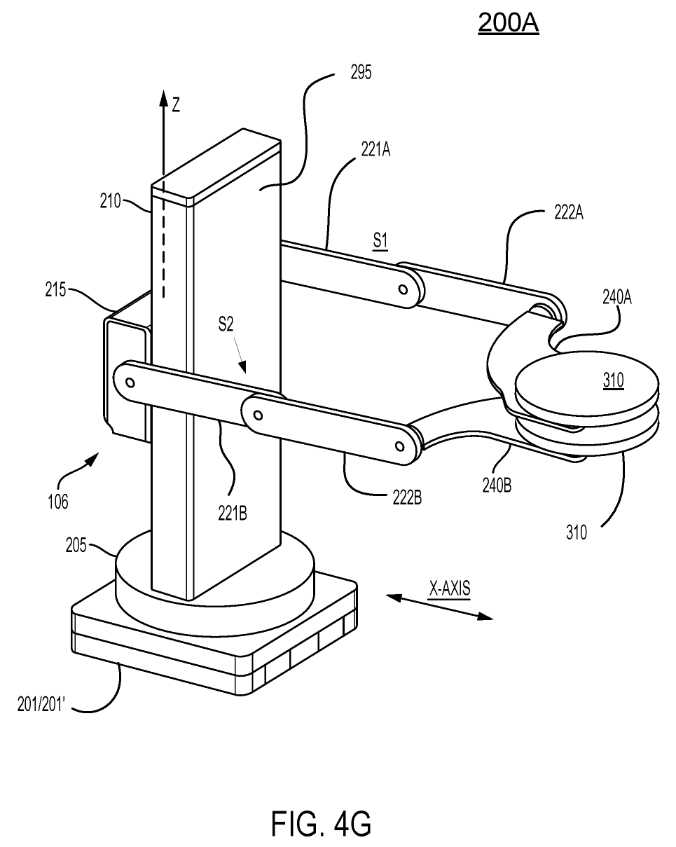

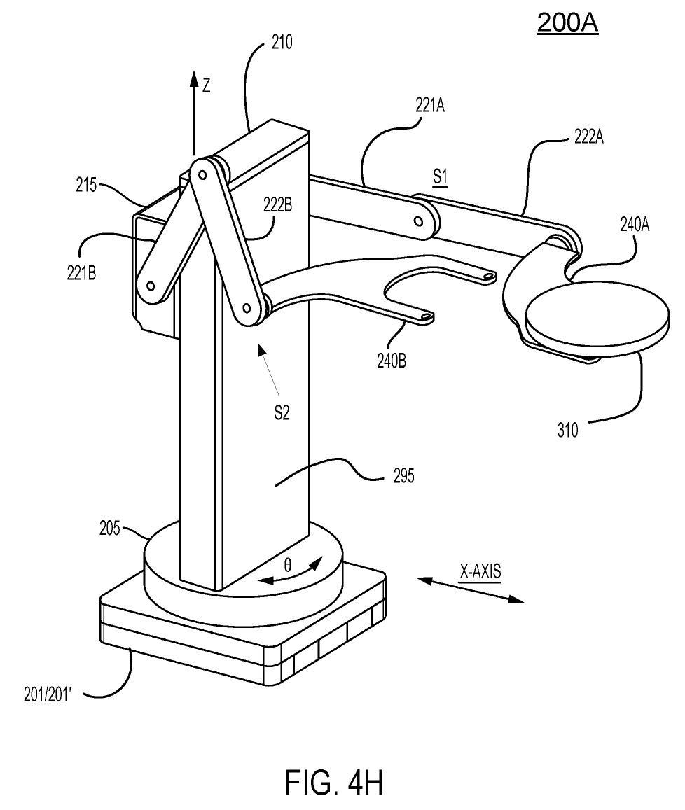

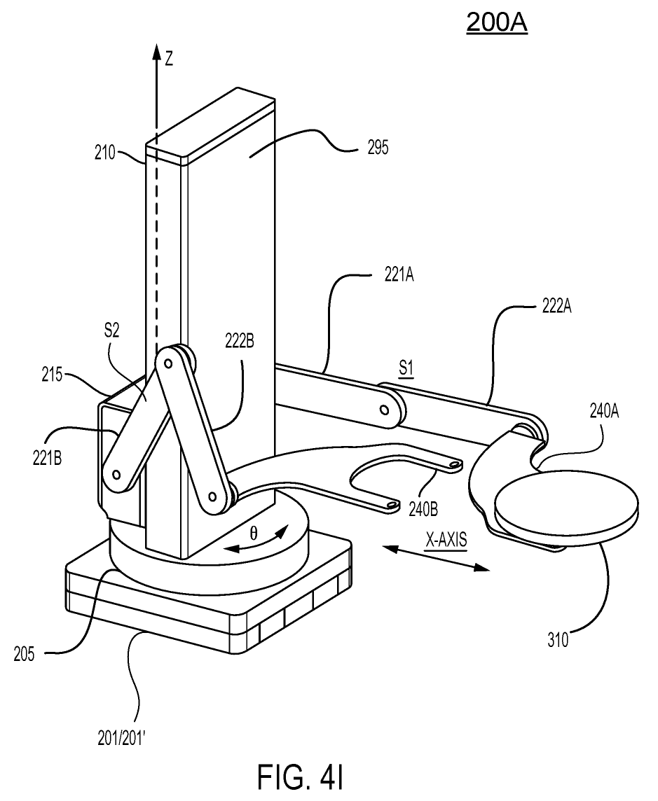

FIGS. 4A-4I are illustrations of perspective views of a robotic structure 200A that is configured for vertically oriented arm motions, in accordance with embodiments of the present disclosure. Optionally, the robotic structure 200A of FIGS. 4A-4I may support a track system 430 integration. The perspective views of FIGS. 4A-4I are taken from a first vantage point in space having an unobstructed view of the front side 295 of the robotic structure 200A. More particularly, FIGS. 4A-4I show varying positions of the arms S1 and S2 of the robotic structure 200A including full extension, half extension, and full retraction. For example, arms S1 and S2 are shown extending and retracting for purposes of extracting, transporting, and placing substrates, modules, DUTs throughout testing stations of a testing system, during testing and/or assembly processes. In some embodiments, full retraction of at least one of the arms S1 and S2 is possible, wherein a corresponding gripper(s) (e.g., end-effector) is configured to allow for full retraction. FIGS. 4A-4I are purely for illustration purposes, as many different configurations for arms S1 and S2 of the robotic structure 200A not shown are supported. In some embodiments, full retraction of at least one of the arms S1 and S2 is possible, wherein a corresponding gripper(s) (e.g., end-effector) is configured to allow for full retraction.

The robotic structures of FIGS. 4A-4I and throughout this specification are configured for handling various objects and/or devices, in accordance with embodiments of the present disclosure. For instance, in some embodiments, robotic structures 200A of FIGS. 4A-4I are configured for handling wafers and/or substrates 310, wherein the robotic structure includes grippers configured with and/or interfacing with end effectors. Other embodiments disclose robotic structures (e.g., 200E) that are configured for handling devices, modules, and/or DUTs, wherein the robotic structure includes gripers configured with and/or interfacing with carrier portions (e.g., carriers and/or trays). As previously described, other embodiments disclose the use of other types of grippers configured for handling any of a variety of objects, carriers, trays, DUTs, etc.

In particular, FIGS. 4A-4C show the movement of arm S1 from full retraction to full extension, such as when picking up a wafer from a tool system. In FIGS. 4A-4C, arm S2 is in a fully retracted position and the gripper 240B is not handling a substrate 310 or DUT. In one case, gripper 240B may be configured as an end-effector when handling substrates and/or wafers. In the sequence of movements for arm S1, in FIG. 4A, arm S1 is fully retracted and its gripper 240A is not handling a wafer. The gripper 240A for arm S1 is above the gripper 240B for arm S2, though their orientations may be reversed. In FIG. 4B, arm S1 is partially retracted, or rather has moved to a mid-way position between full retraction and full extension. In FIG. 4C, arm S1 is fully extended and is shown after picking up a wafer 310. The same or different movements may be performed to extract the wafer 310 for purposes of transport.

In FIG. 4C and in other figures throughout the specification, the substrate 310 is shown having the same diameter as the gripper 240A. It is understood that the size of substrate 310 or of any other object that is being handled by gripper 240A (e.g., substrate, DUT, device, etc.) is variable. As such, the object, being handled by the corresponding gripper, may be smaller or larger than or of equal size as the corresponding gripper. That is, different grippers may be configured to be smaller or larger than the object being handled. For example, different grippers may be smaller than the substrate footprint or extend beyond the substrate footprint when supporting substrate transfers.

In addition, FIGS. 4A and 4D-4E show the movement of arm S2 from full retraction to full extension, such as when picking up a substrate 310 or DUT from a tool system. In FIGS. 4A and 4D-4E, arm S1 is in a fully retracted position and the gripper 240A is not handling a substrate. In the sequence of movements for arm S2, in FIG. 4A, arm S2 is fully retracted and its end-effector 240B is not handling a substrate. The gripper 240B for arm S2 is shown above the gripper 240A for arm S1, though their orientations may be reversed. In FIG. 4D, arm S2 is partially retracted, or rather has moved to a mid-way position between full retraction and full extension. In FIG. 4E, arm S2 is fully extended and is shown after picking up a substrate 310. The same or different movements may be performed to extract the substrate 310 for purposes of transport.

In addition, FIGS. 4A and 4F-G show the movements of arms S1 and S2 from full retraction to full extension, as both arms are moving to pick up substrates from a testing station or loader. In FIG. 4A both arms are in fully retracted positions, such that arm S1 is fully retracted and its gripper 240A is not handling a substrate 310, and arm S2 is fully retracted and its gripper 240B is also not handling a substrate 310. In the sequence of arms movements, in FIG. 4F each of arms S1 and S2 have moved to a mid-way position between full retraction and full extension. The gripper 240A for arm S1 is shown above the gripper 240B for arm S2, though their orientations may be reversed. In FIG. 4G, each of arms S1 and S2 is fully extended, and each is shown after picking up a substrate 310. The same or different movements may be performed to extract the substrate 310 for purposes of transport.

FIGS. 4H and 4I illustrate how the arms S1 and S2 may be vertically moved along the Z-axis, wherein each of the arms S1 and S2 have additional vertically oriented arm motions, as previously described. In particular, FIG. 4H shows the arms S1 and S2 at a highest Z-position on the Z-tower 210. As shown, arm S1 is fully extended and its gripper 240A is handling a substrate. On the other hand, arm S2 is fully retracted. In addition, FIG. 4I shows the arms S1 and S2 at a lowest Z-position on the Z-tower 210. Again, for purposes of illustration, arm S1 is fully extended and its gripper 240A is handling a substrate, while arm S2 is fully retracted. A full range of positions for each of arms S1 and S2 are supported for any Z-position on the Z-tower 210.

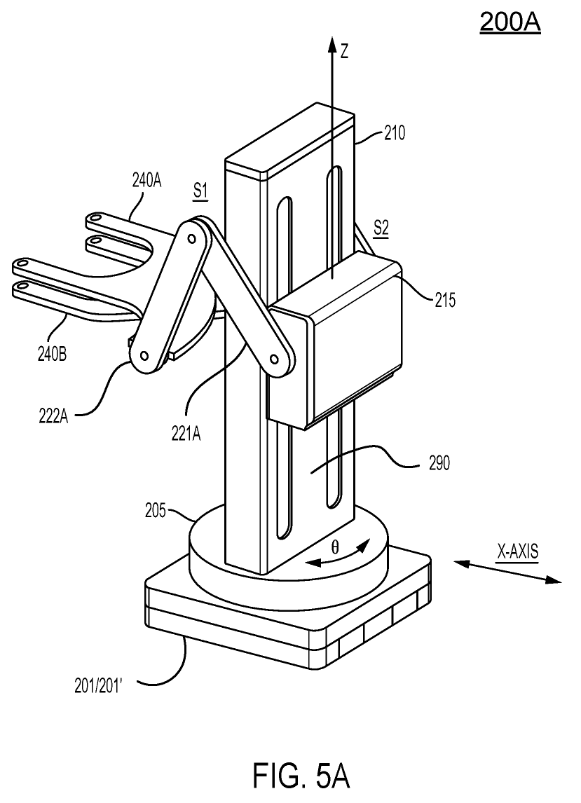

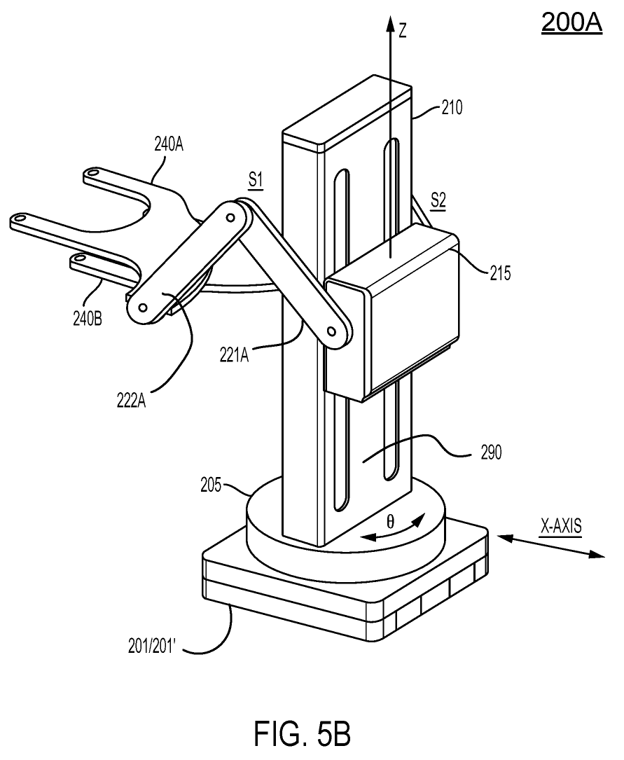

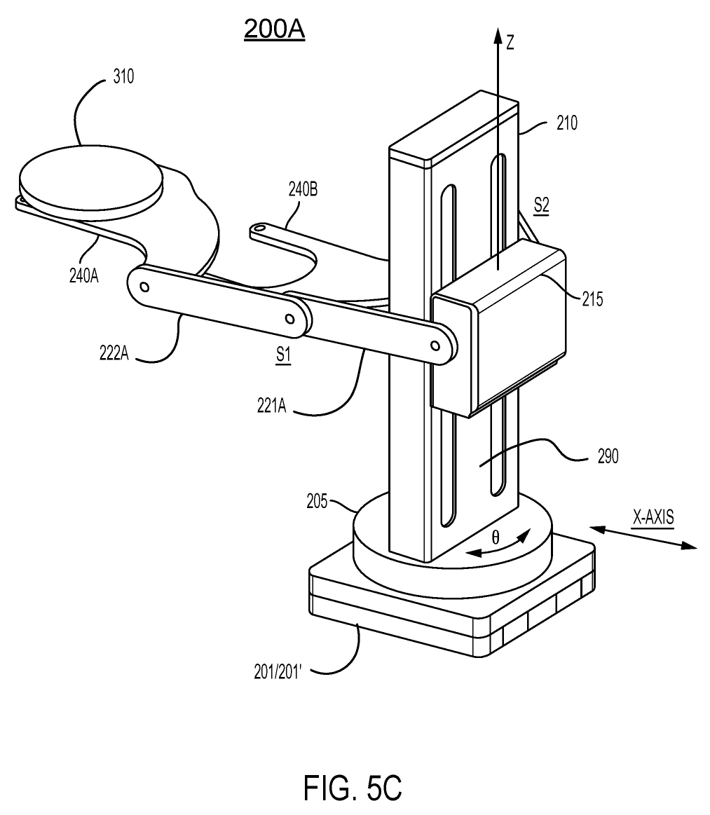

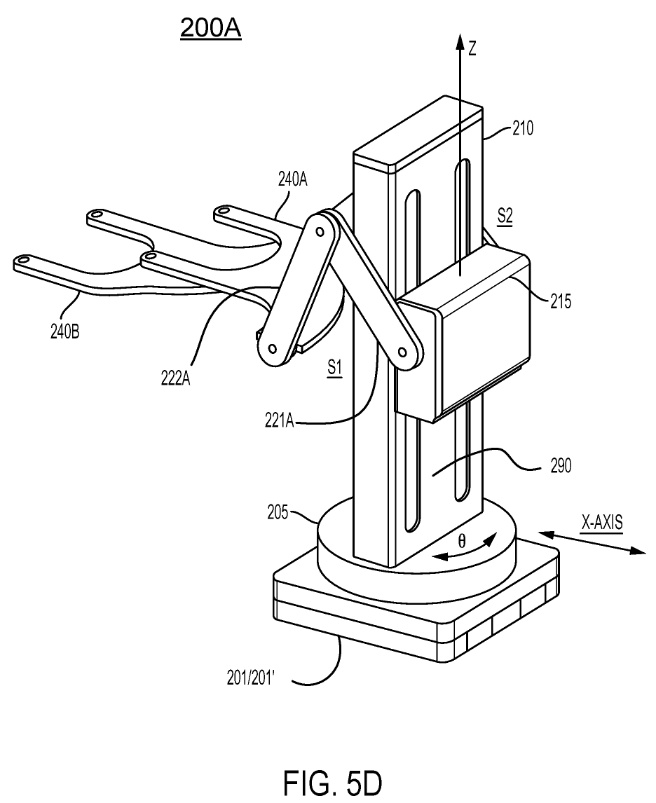

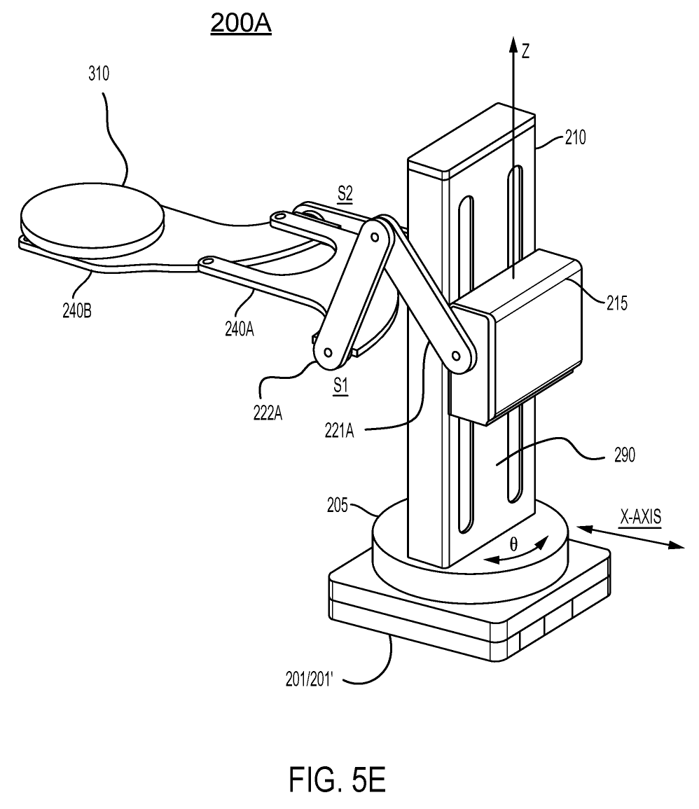

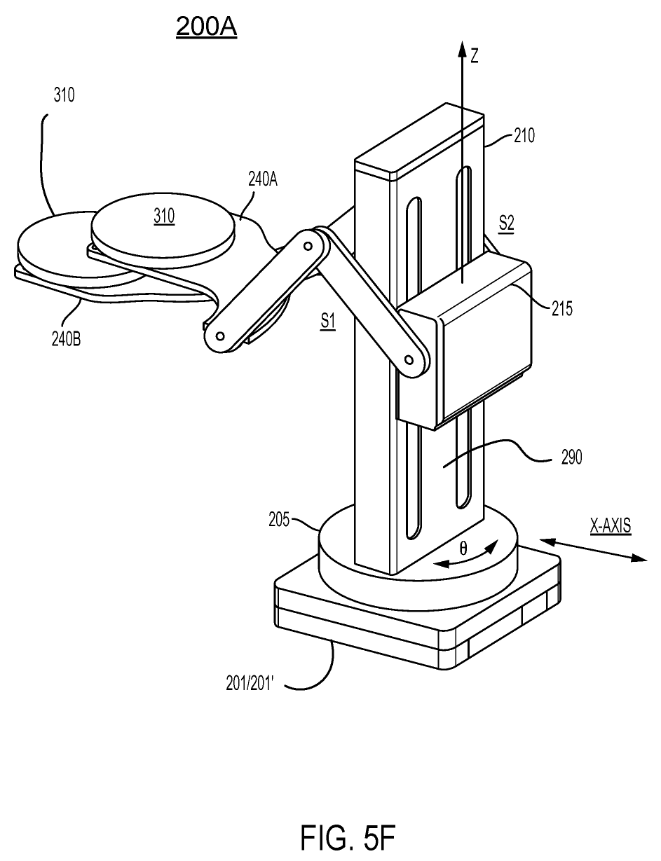

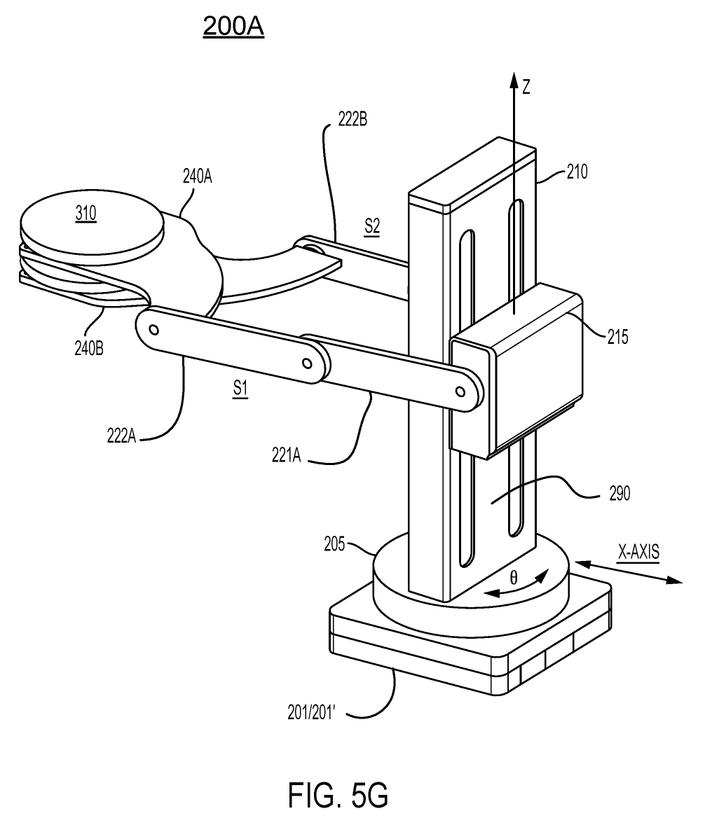

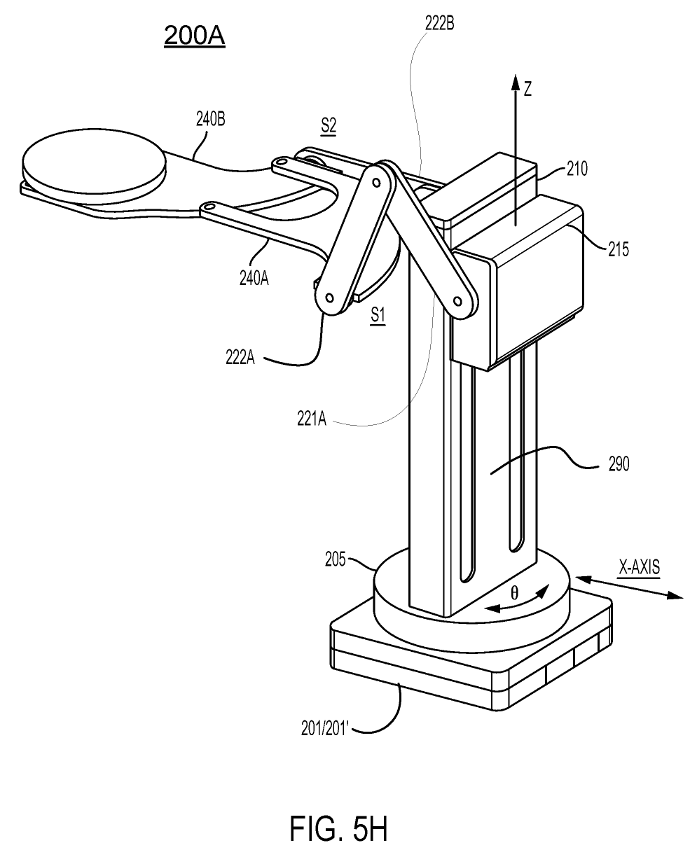

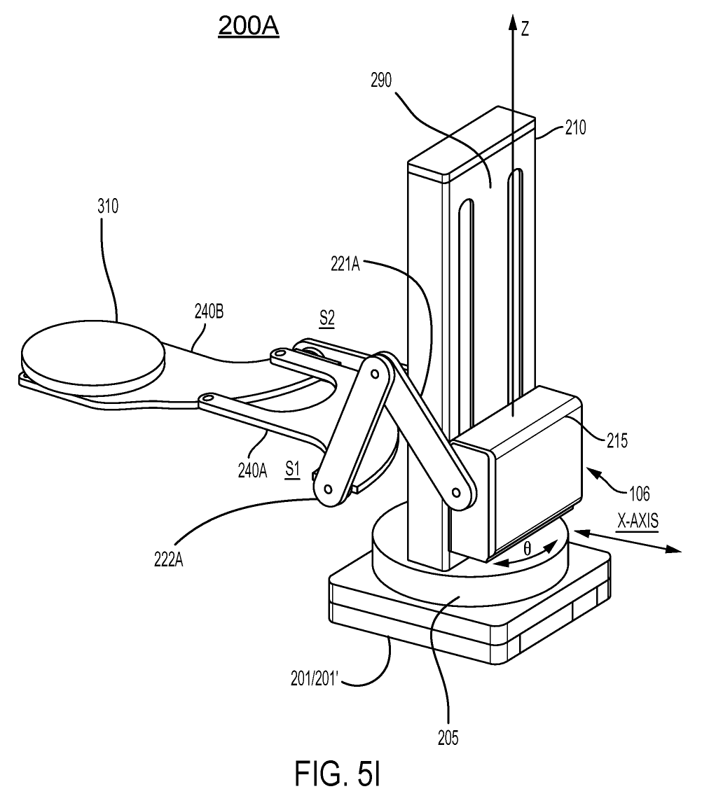

FIGS. 5A-5I are illustrations of perspective views of a robotic structure 200A that is configured for vertically oriented arm motions, in accordance with embodiments of the present disclosure. Optionally, the robotic structure 200A of FIGS. 5A-5I may support a track system 430 integration. The perspective views of FIGS. 5A-5I are taken from a second vantage point in space having an unobstructed view of the back side 295 of the robotic structure 200A. More particularly, FIGS. 5A-5I show varying positions of the arms S1 and S2 of the robotic structure 200A including full extension, half extension, and full retraction. The perspective views of FIGS. 5A-5I closely track and mostly parallel the views of the robotic structure 200A of FIGS. 4A-4I. For example, arms S1 and S2 are shown extending and retracting for purposes of extracting, transporting, and placing wafers throughout testing systems and tool systems of an assembly system. In some embodiments, full retraction of at least one of the arms S1 and S2 is possible, wherein a corresponding gripper(s) (e.g., end-effector) is configured to allow for full retraction. FIGS. 5A-5I are purely for illustration purposes, as many different configurations for arms S1 and S2 of the robotic structure 200A not shown are supported.

The robotic structures of FIGS. 5A-5I and throughout this specification are configured for handling various objects and/or devices, in accordance with embodiments of the present disclosure. For instance, in some embodiments, robotic structures 200A of FIGS. 5A-5I are configured for handling wafers and/or substrates 310, wherein the robotic structure includes grippers configured with and/or interfacing with end effectors. Other embodiments disclose robotic structures (e.g., 200E) that are configured for handling carrier portions 20 that are further configured for interfacing with DUTs, wherein the robotic structure includes grippers configured with and/or interfacing with carriers and/or trays, for example. As previously described, other embodiments disclose the use of other types of grippers configured for handling any of a variety of objects, carriers, trays, DUTs, etc.

In particular, FIGS. 5A-5C show the movement of arm S1 from full retraction to full extension, such as when picking up a substrate from a testing station or multi-device carrier. In FIGS. 5A-5C, arm S2 is fully retracted and its gripper 240B is not handling a substrate. In the sequence of movements for arm S1, in FIG. 5A, arm S1 is fully retracted and its gripper 240A is not handling a substrate. In FIG. 5B, arm S1 is partially retracted, or rather has moved to a mid-way position between full retraction and full extension. In FIG. 5C, arm S1 is fully extended and is shown after picking up a substrate 310. The same or different movements may be performed to extract the substrate 310 for purposes of transport.

In addition, FIGS. 5A and 5D-5E show the movement of arm S2 from full retraction to full extension, such as when picking up a substrate from a testing station or multi-device carrier. In FIGS. 5A and 5D-5E, arm S1 is fully retracted and its end-effector 240A is not handling a substrate. In the sequence of movements for arm S2, in FIG. 5A, arm S2 is fully retracted and its gripper 240B is not handling a wafer. The gripper 240B for arm S2 is shown below the gripper 240A for arm S1, though their orientations may be reversed. In FIG. 5D, arm S2 is partially retracted, or rather has moved to a mid-way position between full retraction and full extension. In FIG. 5E, arm S2 is fully extended and is shown after picking up a substrate 310. The same or different movements may be performed to extract the substrate 310 for purposes of transport.

In addition, FIGS. 5F-G show the movements of arms S1 and S2 from full retraction to full extension, as both arms are moving to place substrates into a testing station, for example. Previously, each of arms S1 and S2 have picked up wafers 310. In the sequence of arms movements, in FIG. 5F arm S1 has moved to a mid-way position between full retraction and full extension. Also, arm S2 has moved to a fully extended position. The end-effector 240A for arm S1 is shown above the gripper 240B for arm S2, though their orientations may be reversed. In FIG. 5G, each of arms S1 and S2 is fully extended, and each is shown in positions for dropping off a substrate 310.

FIGS. 5H and 5I illustrate how the arms S1 and S2 may be vertically moved along the Z-axis, wherein each of the arms S1 and S2 have additional vertically oriented arm motions, as previously described. In particular, FIG. 5H shows the arms S1 and S2 at a highest Z-position on the Z-tower 210. As shown, arm S2 is fully extended and its end-effector 240B is handling a substrate. On the other hand, arm S1 is fully retracted and its gripper 240A is not handling a substrate. In addition, FIG. 5I shows the arms S1 and S2 at a lowest Z-position on the Z-tower 210. Again, for purposes of illustration, arm S2 is fully extended and its gripper 240B is handling a substrate, while arm S1 is fully retracted. A full range of positions for each of arms S1 and S2 are supported for any Z-position on the Z-tower 210.

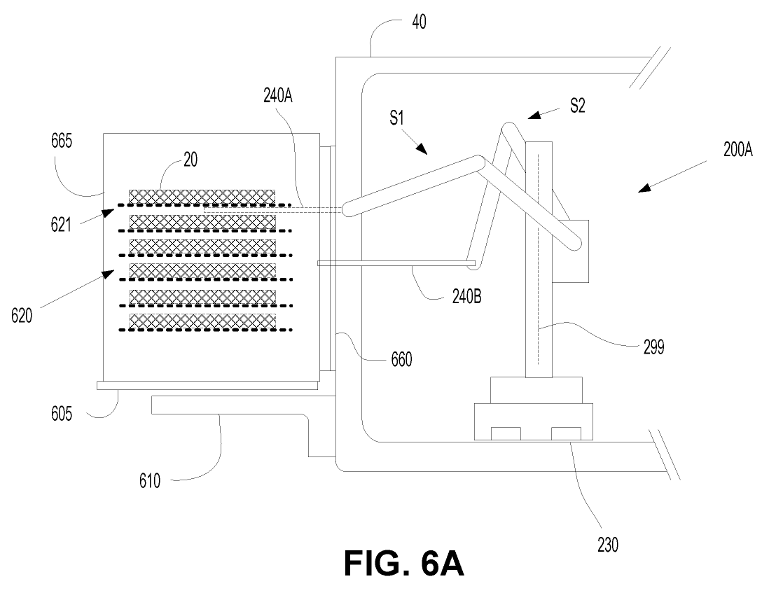

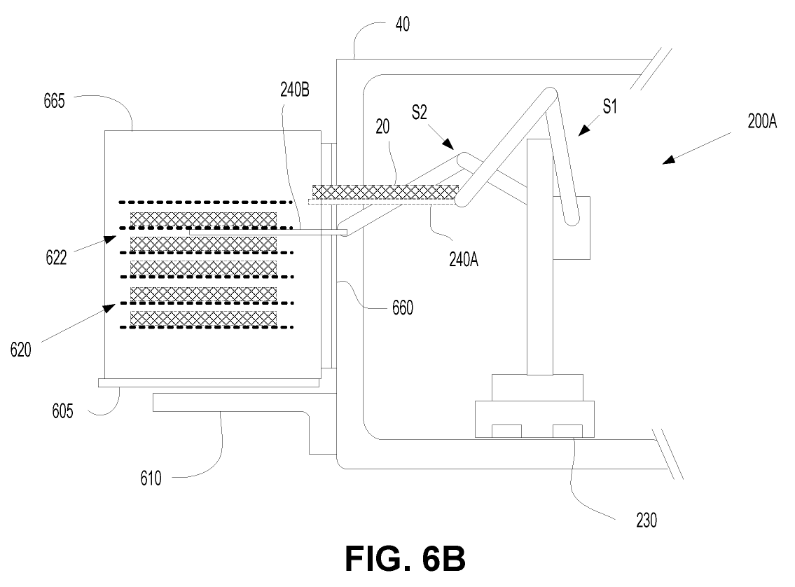

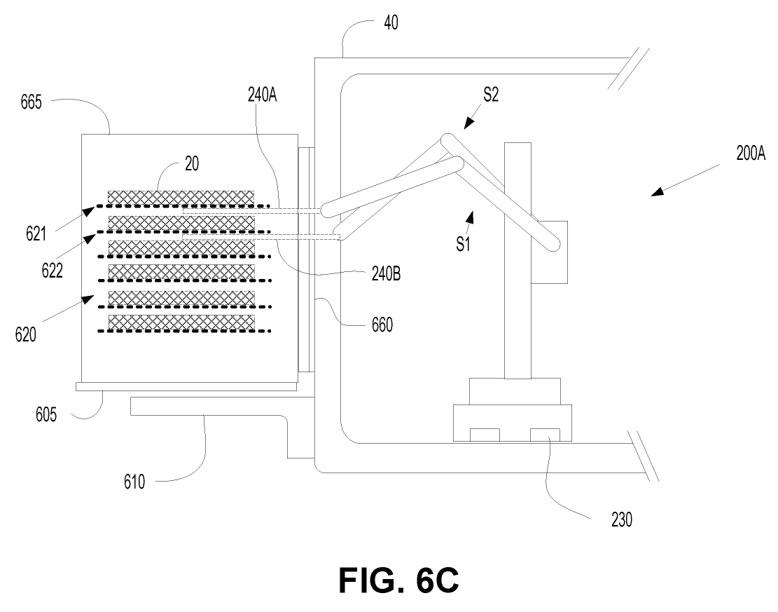

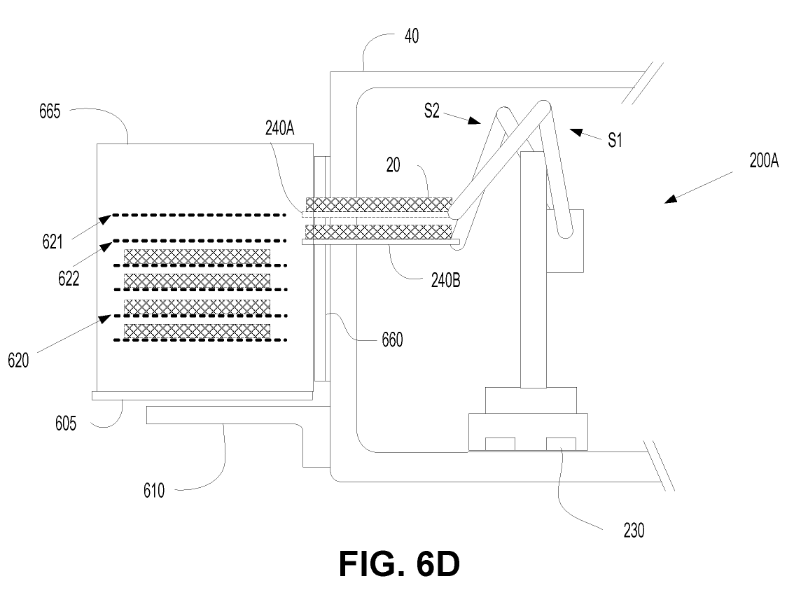

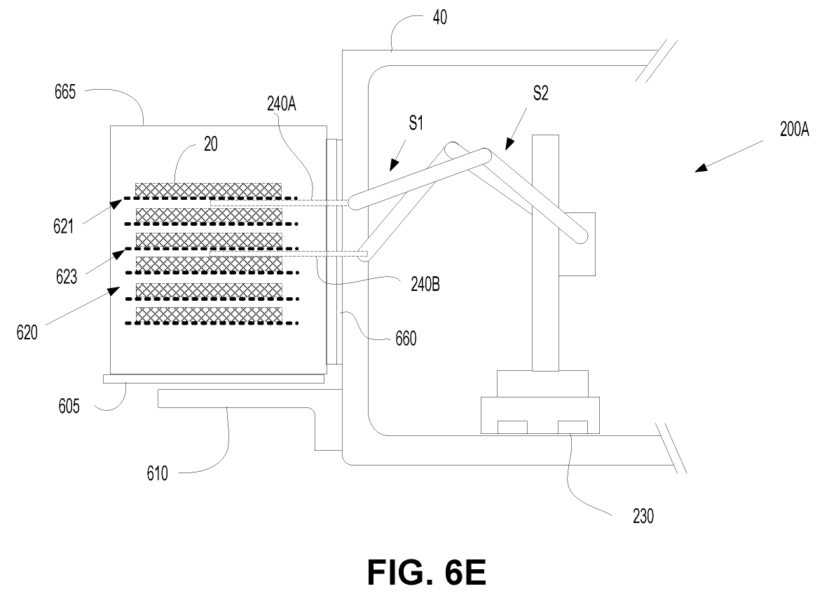

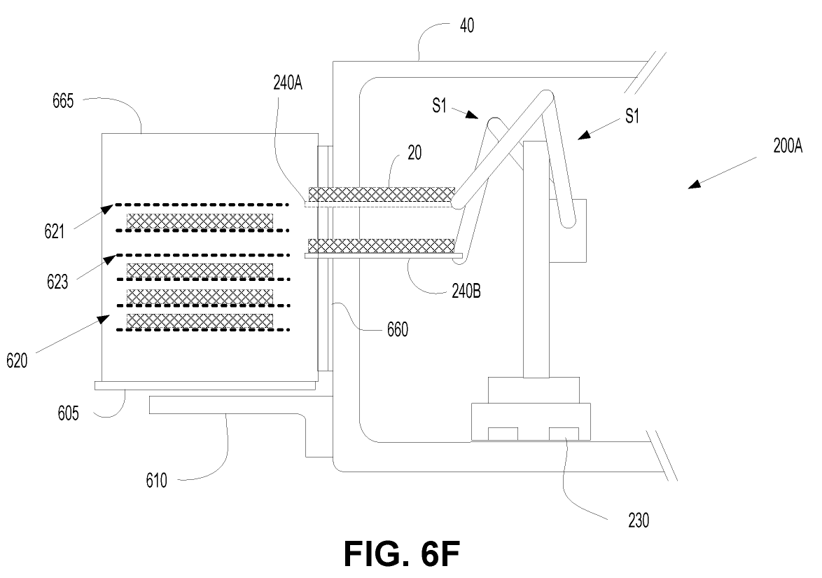

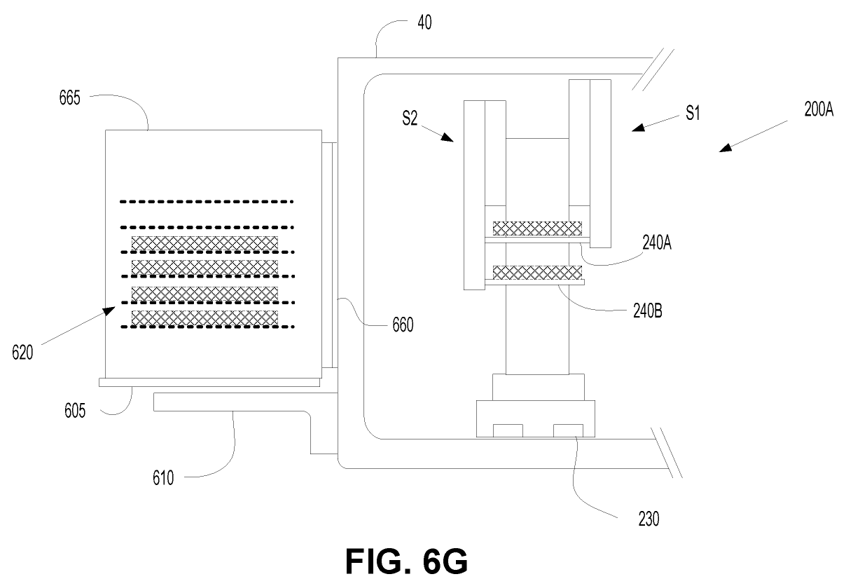

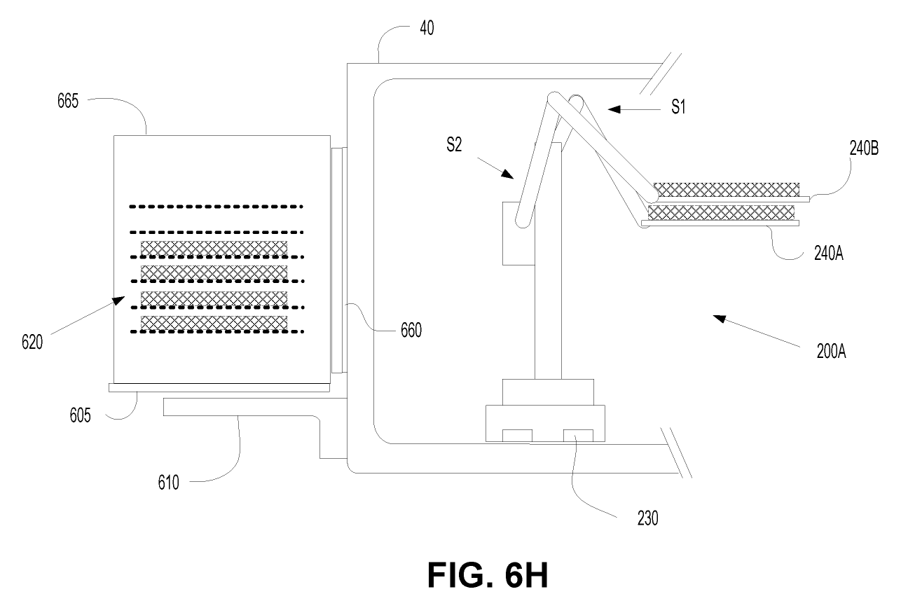

FIGS. 6A-6H illustrate the use of a robotic structure 200A, introduced in FIGS. 2A-2B, within a loader 40 of a testing system, wherein the robotic structure 200A is configured for transporting substrates, modules, DUTs from an open or sealable multi-device carrier 665 to other testing and/or manufacturing stations, in accordance with embodiments of the present disclosure. In particular, the loader 40 may include one or more load ports 660 for receiving a multi-device carrier 665 configured for transporting carriers or trays 20 holding DUTs 25. The load ports 660 are configured as a standard interface between the multi-device carrier 665 and the robotic structure 200A. For example, the load ports 660 are configured to present carriers and/or trays 20 to the robotic structure 200A within the loader 40, wherein the robotic structure is configured to move DUTs handled by carriers and/or trays 20 to a corresponding testing station (not shown).

The carrier 40 may include a handle (not shown) that is configured to mate with a transport system (e.g., an overhead hoist transfer (OHT) system that is configured to move the carrier 40 from testing station to testing station via corresponding loaders 40. The carrier 665 includes a pod shell and a pod door, wherein the pod door engages with a port door of the load port 660 before the pod door is removed from the shell to enable access to the cassette 620 located within the carrier 660. The cassette 620 includes one or more closely spaced slots, wherein each slot is configured for holding a smaller carrier or tray 20. A cassette 620 may have any number of slots.

The loader includes a mounting surface 610 that is configured for supporting a multi-device carrier 665. A locking assembly 605 is attached to the mounting surface, wherein the locking assembly 605 is configured to lock the multi-device carrier 665 into place on the mounting surface 610. Once locked, the multi-device carrier 665 is properly docked to the load port 160, and the pod door may be opened. In that manner, the robotic structure 200A is able to enter the multi-device carrier 665 for DUT (e.g., via carrier 20) extraction and/or placement, and transport of the DUT via carrier or tray 20 into the interior of the loader 40. Further transport may be enabled to move the DUTs 25 via carriers or trays 20 to and from a connected testing station (not shown). In addition, robotic structure 200A may be interfaced or integrated with a track system 230 to enable movement within the loader 40, such as when the loader 40 supports multiple load ports.

The robotic structure 200A located inside the loader 40 is configured as a dual-arm structure, but may be configured to have one or more arms. As shown, robotic structure 200A includes arms S1 and S2, wherein arm S1 is rotatably attached to a gripper 240A configured for DUTs 25. Also, robotic structure 200A includes arm S2 that is rotatably attached to an gripper 240B configured for DUTs. In one embodiment, gripers 240A and 240B may be configured for handling wafers 310, as previously described.

In FIG. 6A, arm S1 is positioned to enter multi-device carrier 665 and access slot 621 for purposes of DUT extraction through a corresponding carrier or tray 20. Movement of the gripper 240A of arm S1 to engage with a carrier or tray 20 in a slot is well known, and needs no further discussion. As shown, arm S2 is positioned so as to not interfere with arm S1, and may be in a retracted position.

In FIG. 6B, arm S1 has picked up a wafer 310 and is moving out of the FOUP 165 and into the interior of the EFEM 150. In addition, arm S2 is positioned to enter FOUP 165 and access slot 622 for purposes of wafer extraction. Movement of end-effector 240B of arm S2 to engage with a wafer in a slot is well known, and needs no further discussion.

In FIGS. 6A-6B, arms S1 and S2 are coordinated to pick up carriers or trays handling DUTs in adjacent slots 621 and 622 in sequential fashion. That is, first arm S1 picks up a carrier or tray 20 from slot 621 and moves out of the multi-device carrier 665, and then arm S2 moves into the multi-device carrier 665 to remove a carrier or tray 20 from slot 622. In FIGS. 6C-6D, arms S1 and S2 are coordinated to simultaneously pick up carriers or trays 20 inside multi-device carrier 665. In particular, FIG. 6C illustrates arms S1 and S2 simultaneously entering FOUP 165 and picking up carriers or trays 20 in adjacent slots 621 and 622. For example, arm S1 picks up carrier or tray 20 from slot 621 and arm S2 picks up carrier or tray 20 from slot 622. FIG. 6D shows arms S1 and S2 simultaneously moving out of multi-device carrier 665 and into the interior of the loader 40. As shown, carriers or trays 20 are absent from slots 621 and 622.

As described previously, in FIGS. 6A-6B, arms S1 and S2 are coordinated to pick up carriers or trays 20 in adjacent slots 621 and 622 in sequential fashion. In FIGS. 6E-6F, arms S1 and S2 are coordinated to simultaneously pick up wafers inside multi-device carrier 665. In particular, FIG. 6E illustrates arms S1 and S2 simultaneously entering multi-device carrier 665 and picking up carriers or trays 20 in slots 621 and 623, wherein the two slots need not be adjacent and may have one or more intervening slots. For example, arm S1 picks up carrier or tray 20 from slot 621 and arm S2 picks up carrier or tray 20 from slot 623. FIG. 6F shows arms S1 and S2 simultaneously moving out of multi-device carrier 665 and into the interior of the loader 40. As shown, carriers or trays 20 are absent from slots 621 and 623.

FIGS. 6G and 6H illustrate the movement of robotic structure 200A (e.g., rotation) within the loader 40 for purposes of moving wafers to and from a testing station (not shown). In particular, FIG. 6G shows a head-on view of the robotic structure 200A, wherein both arms S1 and S2 are handling carriers or trays 20, and may be moving along the track system 230. Gripper 240A of arm S1 is located above gripper 240B of arm S2. After further rotation of the robotic structure 200A within the loader 40, FIG. 6H shows arms S1 and S2 in an orientation such that at full or partial extension, arms S1 and S2 may enter into a connected testing station (not shown).

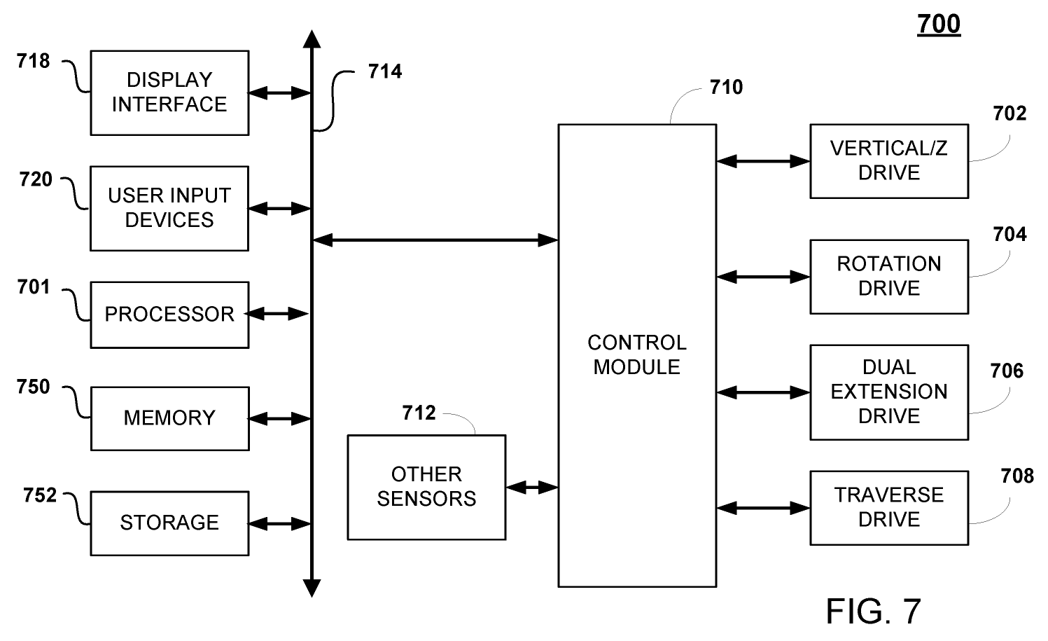

FIG. 7 shows a control module 710 for controlling the systems described above. Control module 710 may be configured within an example device used to perform aspects of the various embodiments of the present disclosure. For example, FIG. 7 illustrates an exemplary hardware system 700 suitable for implementing a device in accordance with one embodiment. Hardware system 700 may be a computer system suitable for practicing embodiments of the disclosure, and may include processors, memory, and one or more interfaces. In particular, hardware system 700 includes a central processing unit or processor 701 for running software applications and optionally an operating system. Processor 701 may be one or more general-purpose microprocessors having one or more processing cores. Further, system 700 may include memory 750 for storing applications and data for use by processor 701. Storage 752 provides non-volatile storage and other computer-readable media for applications and data, and may include fixed disk drives, removable disk drives, flash memory devices, and CD-ROM, DVD-ROM, Blu-ray, HD-DVD, or other optical devices, as well as signal transmission and storage media. The components of system 700 are connected via one or more data buses 714.

The control module 700 may be employed to control devices in the system based in part on sensed values. For example only, the control module 700 may control one or more of vertical drive 702, rotation drive 704, dual extension drive 706 (e.g., used for extending and retracting arms of a robotic system), track system 708, and other sensors 712 based on the sensed values and other control parameters. The control module 700 will typically include one or more memory devices and one or more processors. Other computer programs stored on memory devices associated with the control module 700 may be employed in some embodiments.

Typically there will be a user interface associated with the control module 700. The user interface may include a display interface 718 configured for providing instructions to a display screen and/or graphical software displays of the testing systems, and user input devices 720 such as pointing devices, keyboards, touch screens, microphones, etc., which are used to communicate user inputs to the system 700.

In some implementations, a controller is part of a system, which may be part of the above-described examples. Such systems can comprise testing systems. Still other systems may include semiconductor processing equipment, including a processing tool or tools, chamber or chambers, a platform or platforms for processing, and/or specific processing components (a substrate pedestal, a gas flow system, etc.). All of these systems may be integrated with electronics for controlling their operation before, during, and after testing or processing of a semiconductor wafer or substrate. The electronics may be referred to as the “controller,” which may control various components or subparts of the system or systems. The controller, depending on the processing requirements and/or the type of system, may be programmed to control any of the processes disclosed herein, including the various drive mechanisms, and arm mechanisms for the robotic structures described, and may also include control of the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, substrate transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor substrate or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with, coupled to the system, otherwise networked to the system, or a combination thereof. For example, the controller may be in the “cloud” of all or a part of a fab host computer system, which can allow for remote access of the substrate processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g., a server) can provide process recipes to a system over a network, which may include a local network or the internet.

The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control. Thus as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within their scope and equivalents of the claims.

What is claimed is:

1. A robotic structure providing theta-motion, R-motion and Z-motion comprising:
a platform;
a rotatable base mounted to the platform and adapted to rotate in theta about the platform;
a Z-tower attached to the rotatable base, wherein the Z-tower rotates with the rotatable base;
a vertical drive configured within the Z-tower;
a drive mechanism adapted to integrate with the vertical drive for linear movement along Z-locations of the Z-tower along a Z-axis;
an arm comprising at least two linkages, wherein the arm is rotatably attached to the drive mechanism and is further adapted for Z-articulation in a corresponding vertical plane along the Z-axis for an R-axis, the Z-articulation providing additional Z-movement at each of the Z-locations using the at least two linkages of the arm, wherein the arm comprises a first linkage and a second linkage, wherein the first linkage rotates within a first vertical plane and the second linkage rotates within a second vertical plane, wherein the first vertical plane and the second vertical plane are offset and parallel; and
a gripper adapted to attach to a pivot located at the distal end of the arm and pivotably mounted for rotation relative to the distal end, the gripper adapted to interface with a corresponding object.

2. The robotic structure of claim 1,
wherein the first linkage is attached to the drive mechanism at a rotatable shoulder joint configured for relative movement of the first linkage with respect to the drive mechanism in the corresponding vertical plane, and
wherein a rotatable arm joint connecting the first linkage and the second linkage allows for relative movement between the first and second linkages in the corresponding vertical plane.

3. The robot of claim 2, wherein a first length of the first linkage between the rotatable shoulder joint and the rotatable arm joint is shorter than a second length of the second linkage to increase stiffness of the arm in the vertical direction.

4. The robot of claim 2, wherein each cross-section of the first linkage and the second linkage includes a height dimension and a width dimension, the height dimension being greater than the width dimension to increase stiffness in a load bearing direction.

5. The robot of claim 1, wherein the vertical drive comprises a ball slide assembly.

6. The robot of claim 1, wherein the gripper comprises an end-effector adapted to hold a device under test (DUT).

7. The robot of claim 1, wherein the gripper is adapted to connect with a container having a receptacle area configured for holding one or more objects.

8. The robot of claim 1, further comprising:
an interface adapted at a first end to connect to the pivot located at the distal end of the arm, wherein a second end of the interface is adapted to releasably attach to one or more grippers, each gripper uniquely adapted to handle a corresponding object.

9. The robot of claim 1, wherein the drive mechanism comprises a gear box.

10. (canceled)

11. A robotic structure providing theta-motion, R-motion and Z-motion comprising:
a platform;
a rotatable base mounted to the platform and adapted to rotate in theta about the platform;
a Z-tower attached to the rotatable base, wherein the Z-tower rotates with the rotatable base;
a vertical drive configured within the Z-tower;
a drive mechanism adapted to integrate with the vertical drive for linear movement along Z-locations of the Z-tower along a Z-axis;
a dual arm structure coupled to the drive mechanism and comprising a first arm and a second arm, wherein each arm includes at least two linkages, wherein each arm is rotatably attached to the drive mechanism and is further adapted for Z-articulation in a corresponding vertical plane along the Z-axis for an R-axis, the Z-articulation providing additional Z-movement at each of the Z-locations using the at least two linkages of the corresponding arm, wherein each arm comprises a first linkage and a second linkage, wherein the first linkage rotates within a first vertical plane and the second linkage rotates within a second vertical plane, wherein the first vertical plane and the second vertical plane are offset and parallel;
a first gripper adapted to attach to a first pivot of the first arm, the first pivot located at a distal end of the first arm, wherein the first gripper is pivotably mounted for rotation relative to the distal end of the first arm, the first gripper adapted to interface with a first corresponding object; and
a second gripper adapted to attach to a second pivot of the second arm, the second pivot located at a distal end of the second arm, wherein the second gripper is pivotably mounted for rotation relative to the distal end of the second arm, the second gripper adapted to interface with a second corresponding object.

12. The robotic structure of claim 11,
wherein the first linkage is attached to the drive mechanism at a rotatable shoulder joint configured for relative movement of the first linkage with respect to the drive mechanism in the corresponding vertical plane, and
wherein a rotatable arm joint connecting the first linkage and the second linkage allows for relative movement between the first and second linkages in the corresponding vertical plane.

13. The robot of claim 12, wherein a first length of the first linkage between the rotatable shoulder joint and the rotatable arm joint is shorter than a second length of the second linkage to increase stiffness of the arm in the vertical direction.

14. The robot of claim 12, wherein each cross-section of the first linkage and the second linkage includes a height dimension and a width dimension, the height dimension being greater than the width dimension to increase stiffness in a load bearing direction.

15. The robot of claim 11, wherein the first or second gripper comprises an end-effector adapted to hold a wafer.

16. The robot of claim 11, wherein the first or second gripper is adapted to connect with a container having a receptacle area configured for holding one or more objects.

17. The robotic structure of claim 11, wherein the first gripper of the first arm is located in the same vertical plane of the second gripper of the second arm.

18. The robotic structure of claim 11, wherein each of the first and second arms comprises:
an interface adapted at a first end to connect to the pivot located at the distal end of the first or second arm, wherein a second end of the interface is adapted to releasably attach to one or more grippers, each gripper uniquely adapted to interface with a corresponding object.

19. The robotic structure of claim 11,
wherein the first arm is attached to a first side of the drive mechanism;
wherein the second arm is attached to a second side of the drive mechanism.

20. The robot of claim 11, wherein the drive mechanism comprises a gear box.

21. (canceled)

22. A robotic structure providing theta-motion, R-motion and Z-motion comprising:
a platform;
a rotatable base mounted to the platform and adapted to rotate in theta about the platform;
a Z-tower attached to the rotatable base, wherein the Z-tower rotates with the rotatable base;
a vertical drive configured within the Z-tower;
a drive mechanism adapted to integrate with the vertical drive for linear movement along the Z-tower along a Z-axis;
an arm comprising a first linkage and a second linkage, wherein the arm is rotatably attached to the drive mechanism and is further adapted for z-articulation in a corresponding vertical plane along an R-axis and the Z-axis; and
a universal interface adapted at a first end to connect to the pivot located at the distal end of the arm, wherein a second end of the universal interface is adapted to releasably attach to one or more grippers, each gripper uniquely adapted to interface with a corresponding object, wherein each gripper is pivotably mounted for rotation relative to the distal end, wherein each gripper being adapted to interface with a corresponding object,
wherein the first linkage is attached to the drive mechanism at a rotatable shoulder joint configured for relative movement of the first linkage with respect to the drive mechanism in the corresponding vertical plane,
wherein a rotatable arm joint connecting the first linkage and the second linkage allows for relative vertical movement between the first and second linkages in the corresponding vertical plane.

23. The robot of claim 22, wherein a first length of the first linkage between the rotatable shoulder joint and the rotatable arm joint is shorter than a second length of the second linkage to increase stiffness of the arm in the vertical direction.

24. The robot of claim 22, wherein in a cross-section of the first linkage or the second linkage including a height dimension and a width dimension, the height dimension is greater than the width dimension to increase stiffness in a load bearing direction.

25. The robot of claim 22, wherein a first gripper comprises an end-effector adapted to hold a wafer; and
wherein a second gripper is adapted to connect with a container having a receptacle area suitable for holding one or more objects.
